(19) United States
(12) Patent Application Publication
(10) Pub. No.: US 2026/0093028 A1
(43) Pub. Date: Apr. 2, 2026

(54) METHODS, ARCHITECTURES, APPARATUSES, AND SYSTEMS FOR PHASE-BASED SENSING

(71) Applicant: InterDigital Patent Holdings, Inc., Wilmington, DE (US)

(72) Inventors: Remun Koirala, London (GB); Fumihiro Hasegawa, Westmount (CA); Paul Marinier, Brossard (CA); Ghyslain Pelletier, Montreal (CA); Moon IL Lee, Melville, NY (US); Tao Deng, New York, NY (US); Arman Shojaeifard, London (GB); Kunjan Shah, London (GB); Frank LaSita, Long Beach, NY (US)

(21) Appl. No.: 18/902,394

(22) Filed: Sep. 30, 2024

(51) Int. Cl. G01S 13/76; G01S 7/00

(52) U.S. Cl. CPC G01S 13/765; G01S 7/006

(57) ABSTRACT

A wireless transmit/receive unit (WTRU) communicates with a wireless network to enhance positioning accuracy. The WTRU receives direct path reference phase and delay information, environmental object (EO) reference information, and positioning reference signal (PRS) resources from the network. Using the PRS resources, the WTRU determines phase and delay measurements for multiple sensing paths to a target object. The WTRU analyzes these measurements along with the direct path and EO reference information to identify paths associated with EOs. Based on this analysis, the WTRU calculates compensated phase and delay measurements for the identified paths. These compensated measurements, along with their uncertainties and details of the EOs, are then reported back to the network. Accurate positioning is achieved by considering EO-related delays and phases, mechanisms are included to validate the timing and relevance of the measurements.

### TECHNICAL FIELD

The present disclosure is generally directed to the fields of communications, software and encoding, including, for example, to methods, architectures, apparatuses, systems related to a sensing task.

### BACKGROUND

Sensing with signals for wireless communications involves the exchange of information between a network and a device (such as a mobile phone), detecting and monitoring environmental conditions, and performing measurements, and determining information (e.g., a position) of one or more target objects.

### SUMMARY

In certain representative embodiments, a method performed by a wireless transmit/receive unit (WTRU) is provided for a sensing task. For example, the method comprises receiving, from the wireless network, environmental object (EO) reference information. Also, for example, the method comprises receiving, from the wireless network, positioning reference signal (PRS) resources. Further, for example, the method comprises, based on the PRS resources, determining: direct path reference phase information and direct path reference delay information for a direct path between the WTRU and the wireless network, and a respective phase measurement and a respective delay measurement for each of a plurality of sensing paths for a target object. In addition, for example, the method comprises analyzing, to identify at least one path of the plurality of sensing paths associated with an EO, the direct path reference phase information, the direct path reference delay information, and the EO reference information for each of the plurality of sensing paths. Moreover, for example, the method comprises determining, based on the analyzing, a respective compensated phase measurement and a respective delay measurement for each of the at least one of the plurality of sensing paths based on the direct path reference phase information and the direct path reference delay information for the direct path. Furthermore, for example, the method comprises transmitting a report to the network indicating the compensated phase measurements.

In certain representative embodiments, a wireless transmit/receive unit (WTRU) for a sensing task is provided. For example, the WTRU comprises a processor. Also, for example, the WTRU comprises a transceiver coupled to the processor. Further, for example, the WTRU is configured to receive, from the wireless network, environmental object (EO) reference information. In addition, for example, the WTRU is configured to receive, from the wireless network, positioning reference signal (PRS) resources. Moreover, for example, the WTRU is configured to, based on the PRS resources, determine: direct path reference phase information and direct path reference delay information for a direct path between the WTRU and the wireless network, and a respective phase measurement and a respective delay measurement for each of a plurality of sensing paths for a target object. Furthermore, for example, the WTRU is configured to analyze, to identify at least one path of the plurality of sensing paths associated with an EO, the direct path reference phase information, the direct path reference delay information, and the EO reference information for each of the plurality of sensing paths. Additionally, for example, the WTRU is configured to determine, based on the analyzing, a respective compensated phase measurement and a respective delay measurement for each of the at least one of the plurality of sensing paths based on the direct path reference phase information and the direct path reference delay information for the direct path. Still further, for example, the WTRU is configured to transmit a report to the network indicating the compensated phase measurements.

In some embodiments, for example, the method includes and the WTRU is configured to receive, from the wireless network, direct path reference phase information and direct path reference delay information for a direct path between the WTRU and the wireless network.

For example, the EO reference information may include EO reference delay information related to the direct path. Also, for example, the method includes and the WTRU is configured to determine a delay uncertainty for at least one of the multiple sensing paths based on the EO reference delay information. Further, for example, the delay uncertainty is compared to a threshold, and if it exceeds the threshold, compensated phase measurements are triggered.

In addition, the EO reference information may include EO reference phase information concerning the direct path. Moreover, for example, the phase information includes relative amplitude and relative phase details with respect to the direct path associated with the EO. Furthermore, for example, the process of determining the compensated phase measurement for each of the sensing paths is carried out with reference to the phase of the direct path.

Additionally, for example, the EO reference information includes a validity time duration associated with the EO. Still further, for example, the method includes and the WTRU is configured to compare the duration of a phase measurement instance to this validity time duration. Even further, for example, if the duration falls within the validity time, the compensated phase measurement for that instance is triggered.

Yet further, for example, the report to the network indicates the delay measurements, the uncertainties of the delay and phase measurements, and one or more compensated EOs.

By utilizing reference phase measurements, the methods, architectures, apparatuses, and systems for carrier phase-based sensing provide benefits such as more accurate determination of sensing target location and material.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a depiction of RSCP and RSCPD measurements for positioning, according to one or more embodiments;

FIG. 3 is a depiction of relative phase measurement for a sensing path with respect to a Line of Sight (LoS) path, according to one or more embodiments;

FIG. 4 is a depiction of a relative delay based sensing method for bistatic sensing, according to one or more embodiments;

FIG. 5 is a depiction of RTT based sensing, according to one or more embodiments;

FIG. 6 is an example sequence diagram for request and reporting phase measurement capabilities, according to one or more embodiments;

FIG. 7 is a depiction of a relative delay range indication for phase measurements, according to one or more embodiments;

FIG. 8 is a depiction of measurement with respect to two different Positioning Reference Signal (PRS) resources, according to one or more embodiments;

FIG. 9 is a depiction of delay measurement as a trigger condition for EO phase compensation, according to one or more embodiments; and

FIG. 10 is a flow chart illustrating a method performed by a WTRU for a sensing task, according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

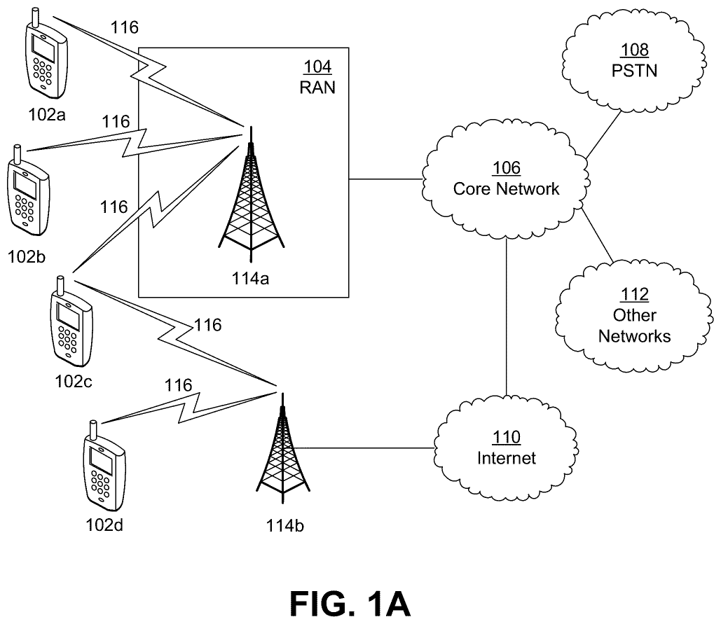

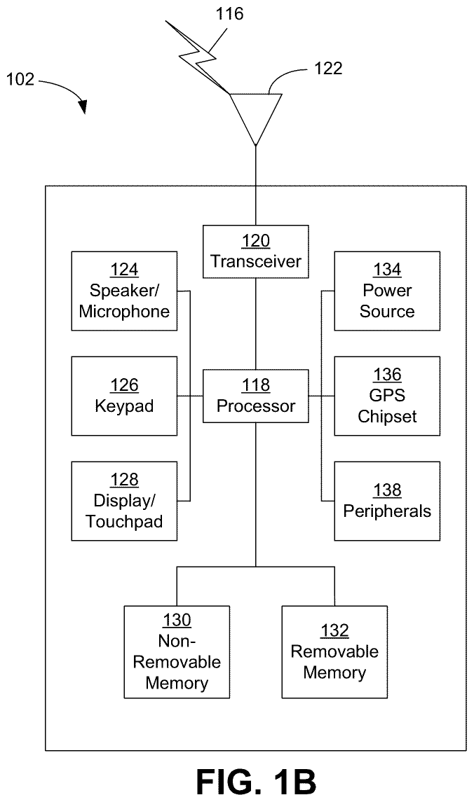

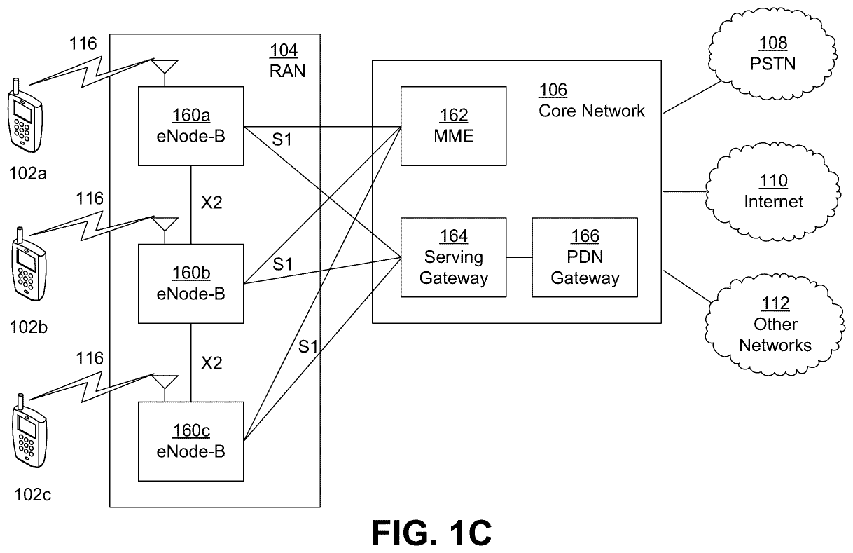

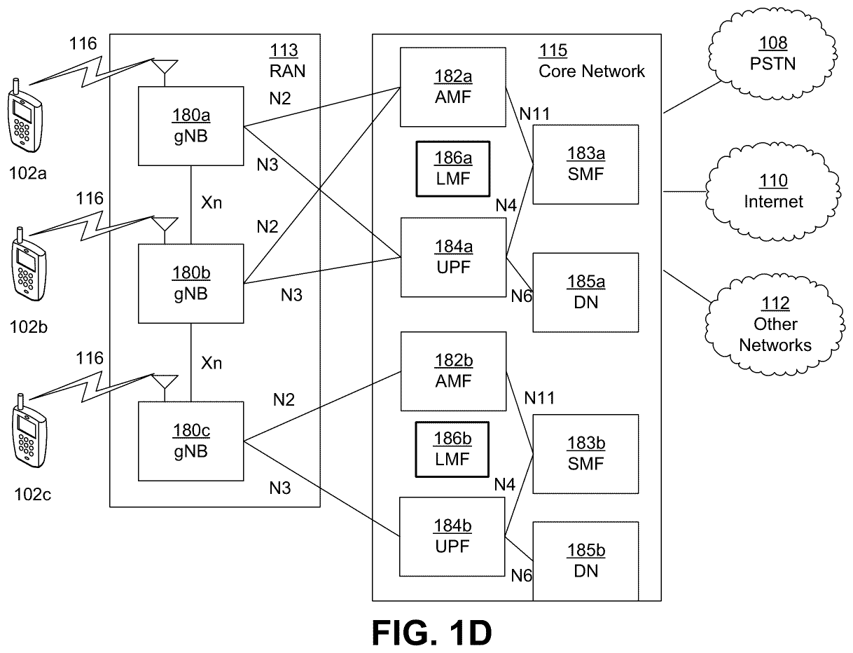

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). The frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of the elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of the component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, routing of location information towards location management functions (LMFs) 186a, 186b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of the elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

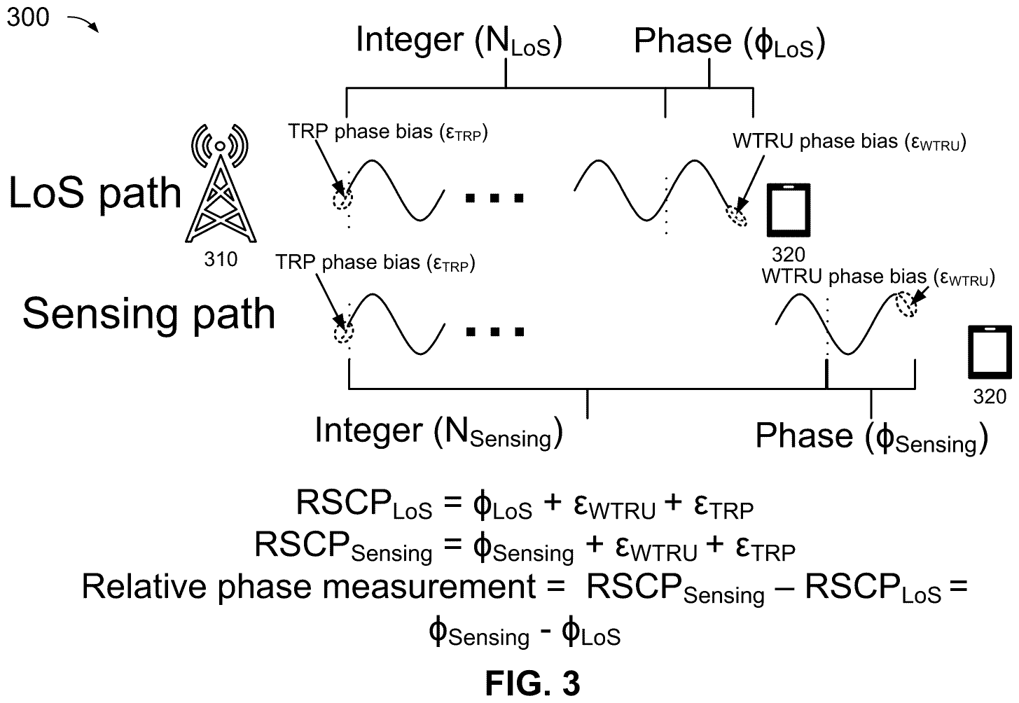

Methods, architectures, apparatuses, and systems for carrier phase-based sensing are provided. The sensing may occur as part of NR ISAC. For example, a WTRU (e.g., one of the WTRUs 102a, 102b, 102c, 102d, of FIGS. 1A-1D, or any of WTRU 320, 420, 530, 620, 820, 920, or the like, of FIGS. 3-9, respectively; hereinafter referred to as WTRU 102 for brevity) performs relative phase measurements (e.g., with respect to the phase of the direct path) and relative delay measurements (e.g., with respect to the direct path) for sensing. Also, for example, the WTRU 102 determines to compensate the measured phase with EO phase information based on the delay uncertainty for the sensing path.

Sensing involves detecting, estimating, and monitoring conditions of the environment and/or objects within the environment (e.g., shape, size, orientation, speed, location, distances or relative motion between objects, or the like) using RF signals. Sensing in the context of ISAC includes enhancements to 5G systems, different sensing modes, and key performance indicators (KPIs) related to sensing. Different sensing modes include monostatic and bistatic sensing depending on transmitter and receiver locations. Monostatic sensing refers to an architecture with a co-located transmitter and receiver and bistatic sensing refers to a non-co-located transmitter and receiver. Likewise, multi-static sensing refers to the bistatic sensing mode with multiple transmitters and/or receivers.

Phase measurements of a reference signal with respect to a phase of a transmitted signal can provide a signal propagation duration. However, since the measured phase of OFDM signals ranges from 0 to 2π, an integer wavelength component of the propagation duration cannot be measured just from phase measurements, hence, an integer ambiguity problem occurs.

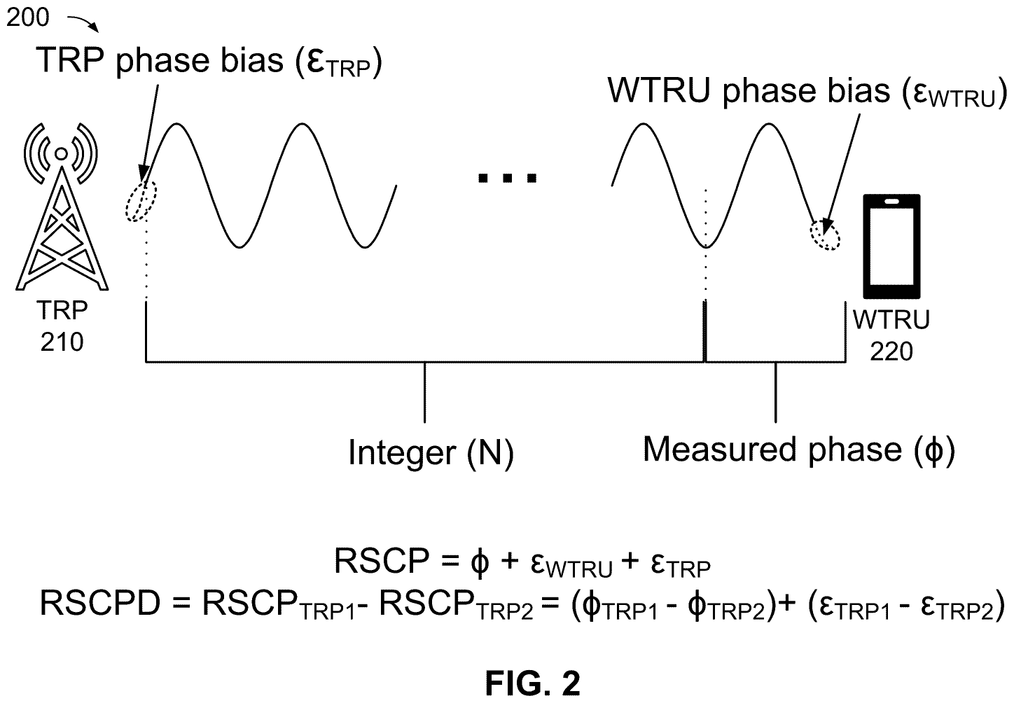

For example, as illustrated in FIG. 2, a plot 200 of a propagation distance between a transmission/reception point (TRP) 210 and a user equipment (UE or WTRU) 220 corresponds to an integer number of wavelengths (N) and a measured phase (φ). However, due to the phase measurements being within the 0 to 2π range, N is not measurable.

Additionally, a phase measurement of a reference signal with respect to different receiver (Rx) antenna elements in an antenna array can provide information regarding angle of arrival (AoA) measurements. Likewise, a difference of phase measurement in time can provide Doppler shift measurements.

FIG. 2 also presents the RSCP and RSCPD measurements for positioning. For example, in FIG. 2, the RSCP and the RSCPD measurements for positioning may be according to the following equations (1) and (2), respectively:

$$RSCP = ϕ + {ε}_{WTRU} + {ε}_{TRP} \qquad ( 1 )$$

$$RSCPD = {RSCP}_{TRP 1} - {RSCP}_{TRP 2} = ( {ϕ}_{TRP 1} - {ϕ}_{TRP 2} ) + ( {ε}_{TRP 1} - {ε}_{TRP 2} ) \qquad ( 2 )$$

where ε_{TRP} is TRP phase bias, ε_{WTRU} is WTRU phase bias, and N is Measured Phase.

Carrier phase-based positioning is provided for highly accurate positioning. Owing to the higher resolution of the phase measurements compared to the delay-based measurement methods (e.g., reference signal time difference (RSTD), WTRU Rx-Tx time difference, time of arrival (ToA), or the like), phase based positioning methods improve positioning accuracy. The phase measurements (e.g., reference signal carrier-phase (RSCP) measurements and reference signal carrier-phase difference (RSCPD) measurements) correspond to a first path of a received signal for uplink and downlink positioning methods. The phase difference measurements eliminate the WTRU phase bias. For example, as illustrated in FIG. 2, the RSCP measurements contain both WTRU and TRP phase biases (e.g., ε_{WTRU} and ε_{TRP}); whereas the RSCPD measurements only contain TRP phase biases (ε_{TRP}).

Additionally, the phase measurements are reported together with measurements such as RSTD or WTRU Rx-Tx time difference. The integer ambiguity problem for the phase measurements is resolved as described in greater detail herein.

In certain representative embodiments, functionalities and support dedicated to sensing are provided for New Radio (NR). NR positioning is provided utilizing DL and/or UL reference signals, architecture, protocols, or the like. Sensing features are provided based on NR positioning features.

For multipath measurement, a reference signal received path power (RSRPP) measurement for a Downlink-Positioning Reference Signal (DL-PRS) and per path reporting of reference signal time difference (RSTD) and/or WTRU Rx-Tx time difference and/or DL-PRS-RSRPP are provided.

Phase measurements (e.g., RSCP, RSCPD, or the like) corresponding to the first path of arrival, positioning a WTRU 102, and/or reporting the phase measurements are provided.

In certain representative embodiments, a location of an object is determined with high accuracy. Solutions to problems associated with timing resolution are provided to achieve high accuracy in object positioning. For example, a WTRU 102 is provided to achieve higher accuracy sensing with carrier phase measurements.

In certain representative embodiments, a WTRU 102 performs and reports relative phase and delay measurements (e.g., with respect to the direct path) for the sensing path. For example, the WTRU 102 determines to use environmental object (e.g., EO) phase correction in its measurements based on the determined uncertainty in the relative delay measurement of the sensing path.

In certain representative embodiments, a WTRU 102 is configured to perform at least one of the following: receiving one or more PRS resource configurations, receiving reference environmental object (EO) information, receiving PRS resources, determining a sensing path, determining a compensation for measured information, utilizing triggers for compensation, reporting, combinations of the same, or the like. For example, the WTRU 102 receives PRS resource configurations for DL phase-based sensing method with a relative delay range (e.g., with respect to direct path). Also, for example, the WTRU 102 receives reference EO information from the network. Further, for example, the reference EO information includes at least one of relative delay (e.g., with respect to direct path) associated with the EOs, reference amplitude and relative phase information (e.g., with respect to direct path) associated with the EOs, validity time durations of the reference EOs, combinations of the same, or the like. In addition, for example, the WTRU 102 receives PRS resources and performs at least one of per path RSRPP, relative phase measurements (e.g., with respect to the phase of the direct path), relative delay measurements (e.g., with respect to the direct path), combinations of the same, or the like, e.g., within an indicated relative delay range. Moreover, for example, for each time measurement per path, the WTRU 102 determines an associated time measurement uncertainty. Furthermore, for example, the WTRU 102 determines a sensing path based on measured RSRPP of a path within the relative delay range above a threshold. Additionally, for example, the WTRU 102 determines to compensate the measured phase based on the measured EO assistance information for the sensing path. Still further, for example, compensation is triggered, for example, by at least one of the following: whether a delay uncertainty for the sensing path is above a threshold, whether a measurement instance is within a validity time associated with the EO, combinations of the same, or the like. Even further, for example, the WTRU 102 reports at least one of the compensated relative phase measurement, relative delay measurement, associated uncertainties, the compensated EOs, combinations of the same, or the like.

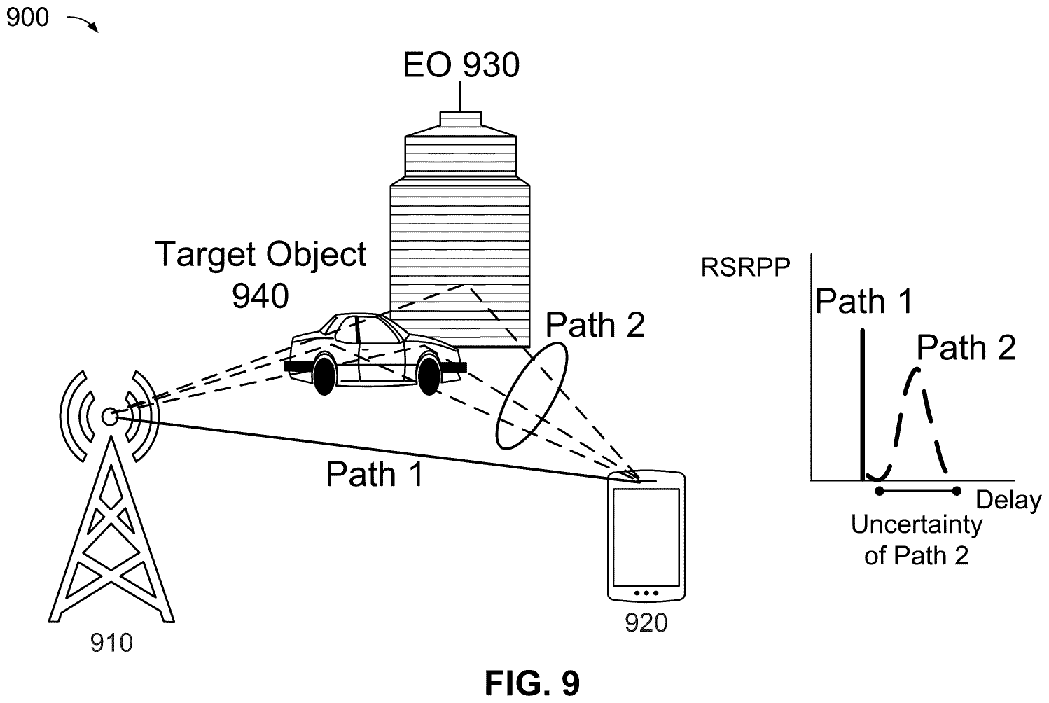

See, for example, FIG. 3 and related descriptions for disclosure regarding relative phase measurement for a sensing path with respect to an LoS path, and, for example, FIG. 9 and related descriptions for disclosure regarding a delay measurement as a trigger condition for EO phase compensation.

Benefits of the methods, architectures, apparatuses, and systems for carrier phase-based sensing include determination and/or assisting the network in the determination of sensing target location with higher accuracy compared to delay and/or angle based sensing methods, and/or sensing target material based on reference phase measurements.

Proposed solutions, components, descriptions, general aspects, and terminology are provided. The descriptions that follow pertain to this disclosure and are exemplary.

A “TRP” (e.g., TRP 310, TRP 410, TRP 510, network 610, TRP 810, TRP 910, or the like) may be used interchangeably with “gNB” or “Positioning Reference Unit (PRU)” or “sensing transmitter” or a “UE” or a “WTRU”. The term “TRP” may be used to indicate an entity (e.g., RAN entity (e.g., RAN 104, RAN 113, or the like)) capable of transmitting a reference signal (e.g., DL-PRS, SSB, CSI-RS, or the like).

A “UE” or a “WTRU” (e.g., 102, 320, 420, 530, 620, 820, 920, or the like) may be used interchangeably with “sensing receiver” and may be used to indicate an entity (e.g., RAN entity (e.g., RAN 104, RAN 113, or the like)) capable of receiving and measuring reference signal (e.g., DL-PRS, SSB, CSI-RS, or the like).

A “Network” may refer to the access mobility function (AMF) (e.g., 182), LMF (e.g., 186), TRP (e.g., 310, 410, 510, network 610, 810, 910, or the like), gNB (e.g., 180), NG RAN (e.g., RAN 104, RAN 113, or the like), or any other entity involved in sensing functionalities (e.g., SMF (e.g., 183)).

A “location” may be used interchangeably with “position,” and a location (e.g., WTRU location, TRP location, or the like) may be expressed in terms of altitude, latitude, geographic coordinate, or local coordinate, for example.

A “reference signal” or “Downlink Positioning Reference Signal (DL-PRS)” or a PRS may refer to any of the positioning and reference signals, e.g., DL-PRS, SRSp, CSI-RS, DM-RS, SSB, or the like.

A “DL-PRS” may refer to any of the downlink positioning or any other reference signals that may be received and/or measured by the WTRU 102, e.g., SSB, CSI-RS, or the like.

The WTRU 102 may receive one or more preconfigured and/or configured thresholds from the network (e.g., LMF (e.g., 186), gNB (e.g., 180)) via downlink physical channel (e.g., PDSCH, PDCCH, or the like) or via lower or higher layer signaling (e.g., DCI, MAC-CE, RRC or LPP message). Herein, the use of term “(pre)configured” is a modifier that refers to “preconfigured and/or configured,” as appropriate in context.

An LMF (e.g., 186) is a non-limiting example of a node or entity (e.g., network node or entity) that may be used for or to support positioning and/or sensing. Any other node or entity (e.g., a server, WTRU (e.g., 102), SMF (e.g., 183)) may be substituted for LMF and still be consistent with this disclosure.

An “ID” may be used interchangeably with “index”.

A “path” may be used interchangeably with “multipath”.

The WTRU 102 may receive configurations (e.g., RS configurations, measurement configurations, reporting configurations, or the like), assistance information, indications, thresholds, messages, or the like from the network (e.g., LMF (e.g., 186), gNB (e.g., 180)) via downlink physical channel (e.g., PDSCH, PDCCH, or the like) or via lower or higher layer signaling (e.g., DCI, MAC-CE, RRC or LTE positioning protocol (LPP) message).

In one example, the WTRU 102 may send the capability information, a measurement report containing the one or more measurements, indications, requests, or the like to the network (e.g., LMF (e.g., 186), gNB (e.g., 180)) via a semi-static (e.g., LPP, RRC) or dynamic message (e.g., UCI, MAC-CE).

A range of values may correspond to at least one of the following: a set of values; values within a maximum value and/or a minimum value where the maximum and a minimum value may correspond to absolute value, or a relative value (e.g., a threshold, with respect to an expected value); combinations of the same; or the like.

The term “measurements” may correspond to at least one or more of RSRP, RSRPP, Relative delay, Doppler shift, AoA, phase measurements, or the like. In one example, the measurement may be per path, per PRS resource, per PRS resource set, per PRS beam, per TRP, or the like.

The terms “phase” or “phase measurements” may be used interchangeably with “RSCP per path”, “relative RSCP”, “RSCPD per path”, “phase difference”, “relative phase”, “relative phase difference”, “RSCP”, “RSCPD” or any other phase measurement quantity applicable for positioning or sensing.

In one example, the configurations, procedures, protocols, or the like applicable to “phase measurements” may be applied to any other measurement quantities (e.g., RSRPP, AoA, relative delay, delay, or the like).

A “sensing path” or a “reflected path” or “path” may be used interchangeably and may be one of the measured paths “e.g., k-th path”.

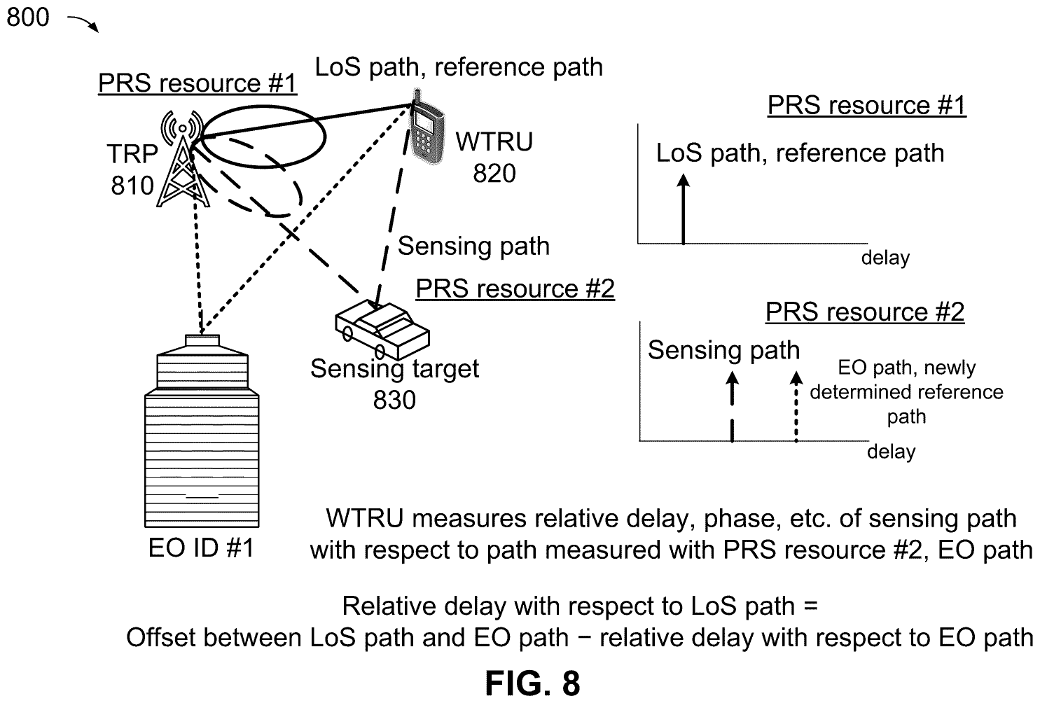

An “environmental object (EO)” (e.g., EO ID #1, at FIG. 8, EO 930 at FIG. 9, or the like) corresponds to any physical entity that may cause reflections or scattering of signals in the environment. EOs may complicate the detection of the intended sensing target by introducing ambiguous or unresolved signals.

The term “EO” may be used interchangeably with unintended sensing targets (e.g., that may be of similar shape, size, material to the sensing target).

The conditions for determination of one parameter (e.g., configuration parameter, e.g., related to at least one procedure) may depend on one or more factors. The WTRU 102 may determine one value for the parameter if at least one of the factors is above a (pre)configured threshold, and another value if the factor is below a (pre)configured threshold.

In the examples described herein, a time indication (e.g., transmission time, timestamp, or the like) may be indicated by absolute time, relative time (e.g., in seconds) compared to a reference time, SFN, slot index, frame index, subframe index and/or symbol index. Examples of “absolute time” may be UTC time, GNSS time, locally defined absolute time (e.g., LTE or NR Time), or the like.

In certain representative embodiments, a configuration for DL-PRS is provided. In one example, a DL-PRS configuration may contain at least one of the following parameters: number of symbols, transmission power, number of DL-PRS resources included in DL-PRS resource set, muting pattern for DL-PRS (for example, the muting pattern may be expressed via a bitmap), periodicity, type of DL-PRS (e.g., periodic, semi-persistent, or aperiodic), slot offset for periodic transmission for DL-PRS, vertical shift of DL-PRS pattern in the frequency domain, time gap during repetition, repetition factor, resource element (RE) offset, comb pattern, comb size, spatial relation, quasi co-location (QCL) information (e.g., QCL target, QCL source) for DL-PRS, number of PRUs, number of TRPs, Absolute Radio-Frequency Channel Number (ARFCN), subcarrier spacing, expected RSTD, uncertainty in expected RSTD, start Physical Resource Block (PRB), bandwidth, bandwidth part identifier (BWP ID), number of frequency layers, start and/or end time for DL-PRS transmission, on and/or off indicator for DL-PRS, TRP ID, DL-PRS ID, cell ID, global cell ID, PRU ID, applicable time window, combinations of the same, or the like. The WTRU 102 may apply a DL-PRS configuration under a condition that the current time is within the applicable time window. The WTRU 102 may receive a beam width of a DL-PRS or boresight direction (e.g., AoD) of DL-PRS from the network. The configuration described herein is not limited to DL-PRS. It can be applicable to any DL RS.

“DL-PRS” and “PRS” and “DL PRS” and “DL-RS” may be used interchangeably herein. “DL-PRS ID(s)” or “DL-PRS resource ID(s)” or “DL-PRS beam ID” or “DL-PRS resource ID(s)” may be associated with one or more TRPs.

Measurement definitions are provided. In this disclosure, the term phase measurements may correspond to at least one of the following measurements: RSCP per path measurement (e.g., RSCP n-th path); relative RSCP measurement (e.g., RSCP of a path with respect to a reference path (e.g., direct path)); RSCPD measurement for one or more path; RSCP per path per antenna component, e.g., RSCP per path measured at one or a group of WTRU 102 antenna elements, WTRU 102 receive one or more RF chain IDs; combinations of the same; or the like.

In one example, regarding the RSCPD measurement for one or more path, the n-th path and the m-th path may correspond to reflections from the same object, characterized by, e.g., a difference between measurements (e.g., AoA, Doppler shift, or the like), e.g., if the difference is below a (pre)configured threshold.

The examples, solutions and procedures presented in this disclosure are primarily exemplified with the relative RSCP measurement; however, the procedures are applicable to other phase measurements and the relevant phase-based sensing procedures, as described herein.

In one example, the phase measurement of a path (e.g., RSCP of a path) (e.g., measured in terms of degrees, radians, or the like) may be defined as the phase of the channel response of the path (e.g., the i-th path), derived from the resource elements carrying the DL PRS configured for measurement. For example, as illustrated in FIG. 3, the RSCP of a path (e.g., sensing path) is the phase of the path reflected through the target object.

In one example, the relative phase measurement (e.g., relative RSCP of a path, or relative RSCP) (e.g., measured in terms of degrees, radians) of a path, may be defined as the phase of the channel response of the path (e.g., at the i-th path), derived from the resource elements carrying the DL PRS configured for the measurement, relative to a reference (e.g., reference path, LoS path, first arrival path, or the like). A WTRU 320 may measure relative RSCP based on the difference between the measured phase (e.g., RSCP) of a path and a (e.g., measured, configured, or the like) reference phase value (e.g., RSCP of another path). In one example, the path may correspond to a multipath component or a path delay.

In one example, the WTRU 320 may receive a configuration from the network indicating the reference for relative phase and/or relative delay measurements.

In one example, the reference for relative phase measurement may either correspond to an indicated phase value (e.g., phase of the transmitted signal, 0 degrees, or the like) or the measured phase of the received DL PRS, e.g., of a path. For example, the reference phase of the transmitted RS may correspond to a phase shifted version of the OFDM signal or any other transmitted signal. For example, the reference phase of the received RS may correspond to the measured phase value corresponding to one path of the received signal. In one example, this reference path may be the direct line of sight (LoS) path, the first arrival path, n-th arrival path, or the like.

As illustrated in FIG. 3, a plot 300 of the relative phase measurement (e.g., relative RSCP) associated with a path (e.g., sensing path) may be the difference between the measured phase (e.g., RSCP_{sensing}) of the sensing path and the measured phase (e.g., RSCP_{LoS}) of the LoS path. The difference between phase measurements of the different paths associated with the transmission from a TRP 310 and reception from the WTRU 320 may eliminate the phase biases (e.g., ϵ_{TRP} and ϵ_{WTRU}, respectively).

For example, in FIG. 3, the relative phase measurement for a sensing path with respect to the LoS path may be according to the following equations (3), (4), and (5):

$${RSCP}_{LoS} = {ϕ}_{LoS} + {ϵ}_{TRP} + {ϵ}_{WTRU} \qquad ( 3 )$$

$${RSCP}_{Sensing} = {ϕ}_{Sensing} + {ϵ}_{TRP} + {ϵ}_{WTRU} \qquad ( 4 )$$

$$Relative phase measurement ( Relative RSCP ) = {RSCP}_{Sensing} - {RSCP}_{LoS} = {ϕ}_{Sensing} - {ϕ}_{LoS} \qquad ( 5 )$$

where ϵ_{TRP} is TRP phase bias, ϵ_{WTRU} is WTRU phase bias, φ_{LoS} is Phase associated with the LoS path, and φ_{sensing} is Phase associated with the sensing path. Also, in FIG. 3, N_{LoS} is an integer associated with the LoS path, and N_{Sensing} is an integer associated with the sensing path.

In one example, the RSCPD of a path may be defined as the difference of RSCP per path measured from DL PRS transmitted in (e.g., in one or more DL positioning frequency layer (PFL)) from a reference TRP and the second TRP. In another example, the RSCPD of a path may be defined as the difference between the relative RSCPs associated with the paths measured from the reference TRP and the second TRP. In one example, the RSCP of a path of the reference TRP may be associated with the RSCP of a path of the second TRP. In one example, the reference TRP for the RSCPD per path measurement may be configured by the network. In one example, the WTRU 320 may be configured to perform and/or report the RSCPD measurement per path for the one or more paths (e.g., pair of associated paths between the TRPs such as a reference path of a reference TRP and a sensing path of a second TRP or TRP2) as the WTRU 320 performs RSTD per path measurement, e.g., according to the following equation (6):

$${RSCPD}_{sensing} = {RSCP}_{referencepath , reference TRP} - {RSCP}_{sensingpath , TRP 2} \qquad ( 6 )$$

In the examples described herein, a reference path for a TRP may refer to the path determined based on a received PRSs from the TRP. For example, the WTRU 320 may receive an indication from the network to determine channel impulse response (CIR) for a TRP with the configured PRS(s). Also, for example, the WTRU 320 may be configured determine CIR for the TRP based on one or more configured PRS(s). In one example, the WTRU 320 may receive an indication which DL PRS to use to determine the CIR for the TRP. Further, for example, based on a channel impulse response, the WTRU 320 may determine the paths associated with the TRP. In addition, for example, RSCPD per path for sensing may be defined by the difference between RSCP of a path associated with the reference TRP and RCSP of a path that is associated with the second TRP.

In one example, the paths (e.g., the reference path of the reference TRP and the reference path of the second TRP) may be associated with each other. For instance, the paths may be associated with at least one of the path measurements (e.g., AoA, doppler shift, relative delay, or the like).

In another example, the RSCPD of a path may be defined as the difference between the RSCP per path measured from the DL PRS transmitted from a TRP (e.g., reference TRP) between a first path (e.g., reference path) and the second path. In one example, the WTRU 320 may be configured to perform and/or report the RSCPD measurement per path for the same path(s) (e.g., first path and second path) as the WTRU 320 performs RSTD per path measurements for. For example, the RSCPD of a sensing path between the reference path of a reference TRP and a sensing path of the reference TRP may be determined as according to the following equation (7):

$${RSCPD}_{sensing} = {RSCP}_{referencepath , referenceTRP} - {RSCP}_{sensingpath , referenceTRP} \qquad ( 7 )$$

In one example, the RSCP measurement per antenna element or a group of antenna elements for a sensing path may be defined as the RSCP of a path measured per antenna component (e.g., antenna element, receiver RF chain, or the like).

In one example, the relative RSCP measurement per antenna element per path may be defined as the RSCP measurement per antenna component of a path (e.g., sensing path) relative to the RSCP measurement of the path of a second antenna element of the WTRU 320.

In one example, the WTRU 320 may be configured to determine and/or report the granularity or the resolution of phase measurement. The WTRU 320 may determine the resolution based on at least one of the following: carrier frequency (e.g., corresponding to the resource element carrying the DL PRS) configured for phase measurement; antenna gain at the TRP and/or the WTRU 320 for transmission and/or reception of the reference signal; bandwidth of the transmitted reference signal; received reference signal sampling rate; number of FFT samples the WTRU 320 is capable to process; received signal-to-noise ratio (SNR) or signal-to-interference noise ratio of the received signal; measured number of resource elements or frequency components carrying the reference signal; combinations of the same; or the like.

Relative delay measurements per path are provided. In one example, a relative delay (e.g., measured in terms of number of symbols, slots, frames, subframes, seconds, or the like) measurement of a path (e.g., i-th path) may be defined as the time duration associated with the delay component (e.g., i-th delay component) of the resource elements that carry received DL RS with respect to the reference delay component (e.g., first delay component of the DL PRS). The granularity of measuring the excess delays may be dependent on the time measurement resolution capability of the WTRU 320. This capability, in one example, may depend on the signal bandwidth for sensing. Additionally, the resolution may also depend on the ability of the WTRU 320 to process (e.g., compute FFT) large frequency domain samples.

In one example, the RSTD measurement per path may be defined as a relative timing difference between the two paths (e.g., reference path and sensing path) from the reference TRP and a second TRP. In one example, one of the two paths may be a reference path (e.g., indicated by the network). In one example, the reference path may be determined as the first path of arrival from the reference TRP.

In one example, the paths (e.g., reference path of the reference TRP and sensing path of second TRP) may be associated with each other. For instance, the paths may be associated based on at least one of the path measurements (e.g., AoA, doppler shift, relative delay, or the like).

In another example, the RSTD measurement per path may be defined as the relative timing difference between two paths of the same TRP (e.g., reference TRP), e.g., between a first path (e.g., reference path) and a second path (e.g., sensing path).

In one example, the WTRU 320 may be configured to measure and/or report the RSTD per path between two paths of the same or different TRPs where one or more path(s) may be the same as configured for RSCPD per path measurements.

In this disclosure, the term “relative delay measurements” may be used interchangeably with “RSTD measurements” or “RSTD per path measurements” or any other time-based measurements.

In one example, the WTRU 320 may be configured to measure and/or report the relative delay measurements for a path or a pair of paths (e.g., of the same TRP or between the TRPs). The WTRU 320 may be configured to report other measurements (e.g., RSCP measurements per path, RSCPD measurement per pair of paths between two TRPs) for the same path or the pair of paths.

Association of the references for the phase measurement is provided. In one example, a WTRU 320 may be configured with the same reference for phase measurement as with the reference for other measurements, e.g., relative delay measurements, AoA per path measurements, RSTD per path measurements, or the like. For example, the WTRU 320 may be configured with the same reference path for the relative RSCP measurements and relative delay measurements or AoA measurements. In another example, the WTRU 320 may be configured with the same reference TRP for the RSCPD measurement and RSTD measurement (e.g., per path RSTD measurement).

In one example, the WTRU 320 may be configured with the reference for only one of the measurements and may assume same reference for other measurements.

For example, the WTRU 320 may be configured with a reference path for relative delay measurements (e.g., first path). The WTRU 320 may also consider the first path for relative phase measurements. For example, the WTRU 320 may be configured with the reference for relative phase measurements (e.g., n-th path) and may consider this path as the reference for other measurements as well (e.g., relative delay measurements, AoA per path measurements, or the like).

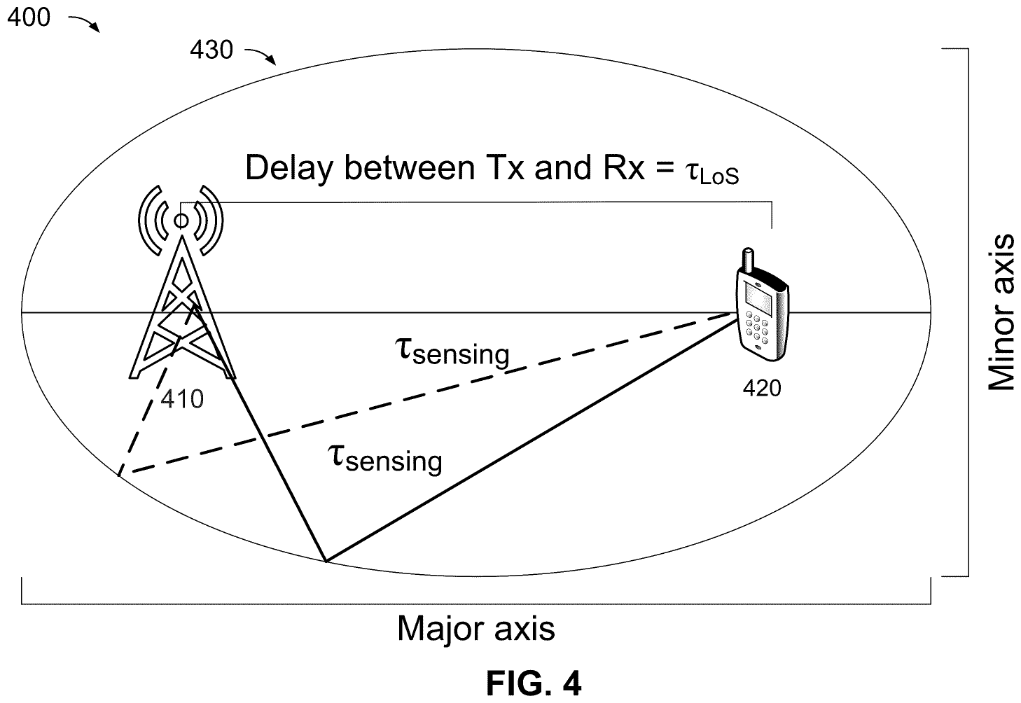

In certain representative embodiments, sensing methods are provided. FIG. 4 illustrates a relative delay based sensing method 400 for bistatic sensing. In one example, a WTRU 420 is be configured to determine an object location based on delay and/or angle measurements. Also, for example, a sensing method includes at least one of relative delay based sensing for bistatic sensing, RTT based sensing in bistatic sensing, RSTD based sensing in bistatic sensing, combinations of the same, or the like.

For example, relative delay based sensing for bistatic sensing is provided. For bistatic sensing, the delay duration of the sensing path (e.g., τ_{sensing}) from a TRP 410 (e.g., TRP1) corresponds to an ellipse 430 with two foci (e.g., the Tx and the Rx locations) with a major axis as R_{TRP1}=c·τ_{sensing}.

For sensing, the relative delay measurement with respect to the LoS path can provide information of the delay of the sensing path, given the delay of the LoS path (e.g., corresponding to the distance between a TRP 410 and the WTRU 420) is known. For example, the delay of the sensing path (e.g., τ_{sensing}) is the sum of the delay of the LoS path (e.g., τ_{LoS}) and the relative delay of the sensing path with respect to the LoS path.

The WTRU 420 may determine the object location based on relative delay measurements from one or more TRPs, associated with the sensing path, with trilateration approach based on the intersection of the ellipses.

In one example, the WTRU 420 may report the relative delay measurement (e.g., in terms of timing units, seconds, number of symbols, slots, frames, subframes, or the like) to the network.

In one example, the WTRU 420 may determine the relative delay measurements based on phase measurements (e.g., relative RSCP measurements with respect to a reference path (e.g., LoS path), RSCP measurement per path, or the like) with one or more TRPs and determine the object location.

In another example, the WTRU 420 may report the relative RSCP for the sensing path to the network. In one example, when the WTRU 420 reports the relative RSCP measurement for the sensing path, the WTRU 420 may also report the relative delay measurement to the network. In one example, the measurements (e.g., relative RSCP and relative delay) may be reported together if at least one of the paths (e.g., the reference path and/or sensing path) of the measurements are the same.

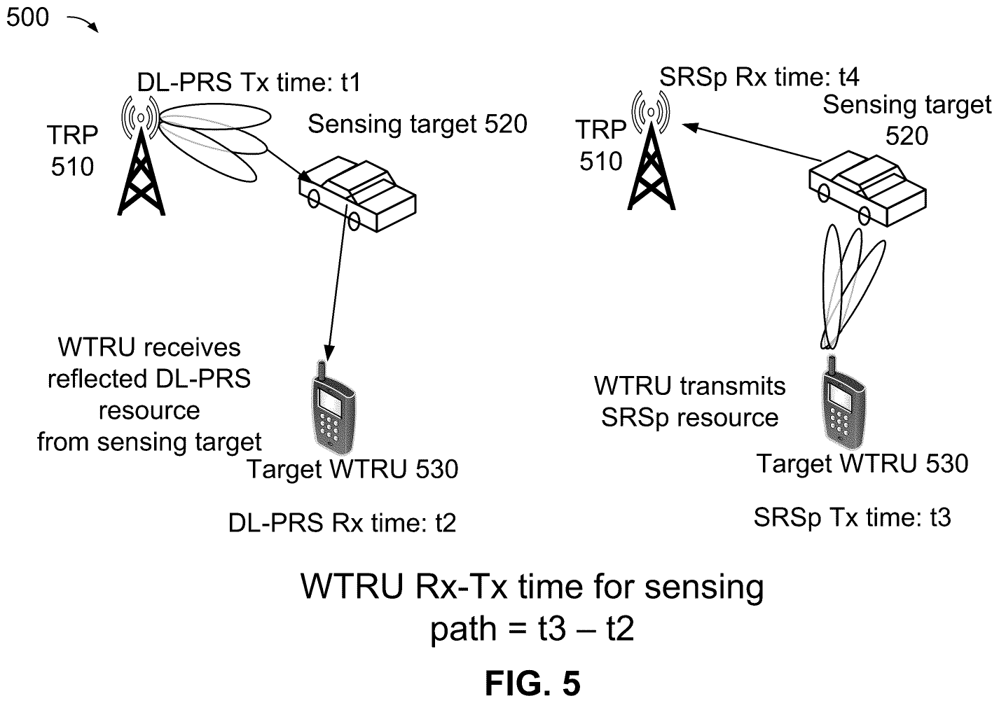

For example, RTT based sensing in bistatic sensing is provided. FIG. 5 illustrates RTT based sensing 500.

RTT based sensing includes determining WTRU Rx-Tx time for a sensing path in accordance with the following equation (8):

$$WTRU Rx - Tx time for sensing path = t 3 - t 2 \qquad ( 8 )$$

where DL-PRS Tx time is t1, DL-PRS time Rx time for the sensing path is t2, SRSp Tx time is t3, and SRSp Rx time for the sensing path is t4.

For bistatic sensing, a WTRU 530 may determine the delay of the sensing path, e.g., the time duration between the transmission of the PRS and the reception of the sensing path of the PRS based on round trip time (RTT) measurements per path (e.g., for sensing path). As illustrated in FIG. 5, the WTRU 530 may receive the DL PRS transmitted by a TRP 510 at time t1 and receives the PRS associated with the reflected path at time t2. The WTRU 530 may then transmit the configured SRSp resources in uplink and record the transmit time. For example, as illustrated in FIG. 5, the WTRU 530 may transmit the SRSp resources and measure the transmit time t3.

The WTRU 530 may report the measurements 530 Rx-Tx time difference corresponding to the time duration t3−t2 in the above example. The WTRU 530 may receive the delay measurement associated with the sensing measurement from the network and may determine the object location based on triangulation approach, as described for relative delay measurements.

In another example, the WTRU 530 may be configured with the gNB Rx-Tx time difference of the reflected path and the WTRU 530 may determine the delay of the sensing path based on the difference between the gNB Rx-Tx time difference and the WTRU Rx-Tx time difference.

In one example, the WTRU 530 may determine the WTRU Rx-Tx time difference for the sensing path based on the phase measurement (e.g., RSCP for the sensing path). The WTRU 530 may determine the location of a sensing target 520 based on measurements of the sensing path with one or more TRPs.

In another example, the WTRU 530 may report phase measurement for the sensing path to the network. When the WTRU 530 reports the phase measurement (e.g., RSCP for the sensing path), the WTRU 530 may also report the WTRU Rx-Tx time difference (e.g., for the sensing path) to the network.

For example, RSTD based sensing in bistatic sensing is provided. In one example, the WTRU 530 may be configured to perform RSTD based sensing, e.g., for the sensing path. In one example, the WTRU 530 may be configured with a reference TRP for RSTD based sensing. The WTRU 530 may measure the difference between the received PRS received from the reference TRP associated with a path (e.g., i-th path) and the second TRP for a path (e.g., j-th path) and determine the RSTD for the sensing path. The WTRU 530 may determine the object location based on one or more RSTD per path measurements for the sensing path. In one example, the paths, e.g., i-th path and the j-th path, may be associated with the sensing target. For example, if the WTRU 530 receives and measures the reference path (e.g., from a reference TRP) in time T1 and sensing path (e.g., from a reference TRP or a second TRP) in time T2, the WTRU 530 may determine the RSTD for the sensing path as the difference between T2 and T1.

In one example, the WTRU 530 may determine the RSCPD value for the sensing path with one or more TRPs and determine the object location based on this sensing method.

In another example, the WTRU 530 may report the RSCPD measurement for the sensing path to the network. In one example, when the WTRU 530 reports the RSCPD measurement for the sensing path, the WTRU 530 may also report the RSTD measurement (e.g., RSTD per path measurement) to the network.

In one example, the WTRU 530 may report the RSTD per path measurements for the sensing path and RSCPD per path measurements for the sensing path together to the network if the references (e.g., reference path, and reference TRP) and/or the measurement paths (e.g., sensing path) between the measurements are the same.

In certain representative embodiments, phase based measurements for sensing are provided. For example, phase based measurements of sensing include at least one of initial PRS configuration for phase measurements, assistance information, measurement procedures, EO phase compensation, integer determination for carrier-phase based sensing, WTRU 530 based objection positioning and material determination, measurement reporting, combinations of the same, or the like.

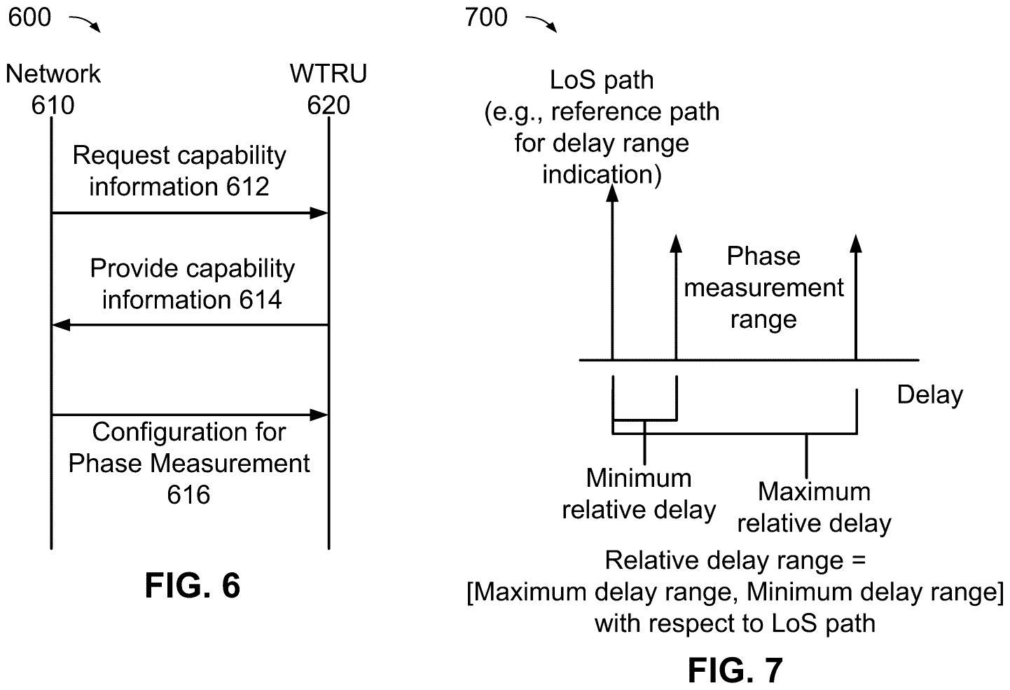

In certain representative embodiments, initial PRS configuration for phase measurements is provided. FIG. 6 illustrates a process 600 for requesting and reporting phase measurement capabilities. For example, the process 600 includes a network 610 requesting (e.g., at 612) capability information, a WTRU 620 providing (e.g., at 614) capability information to the network 610, and the network 610 providing (e.g., at 616) a configuration for phase measurement to the WTRU 620.

In one example, a WTRU 620 may receive the DL-PRS configuration (e.g., for phase measurement) from a network 610 (e.g., LMF (e.g., 186), gNB (e.g., 180), an entity that configures reference signals to the WTRU 620, or the like) in the downlink physical channels, e.g., PDSCH or PDCCH, via higher layer signaling e.g., MAC-CE, RRC, DCI or via LPP messages, or the like.

For example, capability information for carrier-phase based sensing is provided. In one example, the WTRU 620 may be configured to or may determine to report its phase capability to the network 610, as illustrated in FIG. 6. The WTRU 620 may report at least one of the following capability information: the capability to perform, process, and/or report phase measurements (e.g., per path phase measurements); the (e.g., maximum, minimum) number of (e.g., sub-) carrier frequencies on which the WTRU 620 is capable of performing, processing, and/or reporting the measurements (e.g., phase measurements); the (e.g., maximum, minimum) number of frequency bands (e.g., PFL, BWP, or the like) and/or bandwidth supported by the WTRU 620 to perform, process, and/or report the measurements (e.g., phase measurements); the (e.g., maximum, minimum) number of paths the WTRU 620 is capable of performing, processing, and/or reporting measurements (e.g., phase measurements); the (e.g., maximum, minimum) number of samples the WTRU 620 is capable of performing, processing, and/or reporting measurements (e.g., phase measurements); the (e.g., maximum, minimum) number of phase error groups supported and/or reported by the WTRU 620; the (e.g., maximum, minimum) number of TRPs, cells, one or more PRS resources, one or more PRS resource sets, or the like (e.g., per frequency layer) the WTRU 620 is capable of performing, processing, and/or reporting the measurements; the (e.g., maximum, minimum) PRS processing duration (e.g., for phase measurements) supported by the WTRU 620; combinations of the same; or the like.

In one example, the WTRU 620 may receive the configuration from the network 610 after reporting the capability information.

For example, trigger conditions for carrier-phase based sensing configuration requests are provided. In one example, the WTRU 620 may be configured to perform phase measurements for sensing or may request the configurations for phase measurement for sensing based on at least one of the following conditions: the WTRU 620 receives indication (e.g., DL-PRS configuration) from the network for phase measurements; the WTRU 620 determines the (e.g., configured) QoS requirement (e.g., accuracy) for sensing is above a (pre)configured threshold; the WTRU 620 is configured to determine the material of the sensing target; the WTRU 620 determines the error and/or uncertainties and/or resolution associated with measurements (e.g., sensing measurements, relative delay measurements, AoA measurements, Doppler shift measurements, RSRPP measurements, RSRP measurements, or the like) is above a (pre)configured threshold; the WTRU 620 determines the number of multipath components in the channel is below a (pre)configured threshold; the WTRU 620 determines that the PRS bandwidth for sensing is above a (pre)configured threshold; the WTRU 620 determines the measured RSRP of the received PRS resource is above a (pre)configured threshold; the WTRU 620 determines the PRS resource associated with the path with sensing target has a LoS path component, or the like; combinations of the same; or the like.

In one example, based on satisfaction of at least one or more combinations of the triggering conditions, the WTRU 620 may determine to request for phase based configurations from the network.

In certain representative embodiments, assistance information (e.g., for carrier-phase based sensing) is provided. In one example, a WTRU 620 may receive at least one of the following assistance information for phase based sensing: a measurement window, a measurement range indication, one or more path IDs, one or more PRS resource IDs, one or more PRS beam IDs, one or more PRS resource set IDs, a frequency indication, a time indication, a measurement range, EO information, a measurement reference indication, expected sensing target information, measurement correction information, combinations of the same, or the like.

For example, a measurement window is provided. In one example, the WTRU 620 may receive measurement window configurations from the network (e.g., for phase measurements). In one example, the WTRU 620 may be configured to perform the phase measurements only in the indicated measurement window. The WTRU 620 may receive at least one of the following from the network: window ID; start and/or end time (e.g., expressed in terms of relative time or symbol number, slot number, subframe number or frame number); duration (e.g., expressed in terms of number of symbol, slots, subframes, frames, milliseconds, seconds, or the like); offset (e.g., in terms of symbol offset, slot offset, subframe offset, frame offset, relative time offset (e.g., in milliseconds) with respect to a reference time) where the reference time may be the same as the ones mentioned for start and/or end time; periodicity (e.g., expressed in terms of number of symbols, slots, subframes, frames, milliseconds, seconds); combinations of the same; or the like.

For example, the relative time may be with respect to a reference time including at least one of the following: the time instance when WTRU 620 received the one or more configurations from the network; the time instance of indication from the network to activate the measurement window; any other indications, events, or the like; combinations of the same; or the like.

For example, measurement range indication is provided. In one example, the WTRU 620 may receive an indication of a measurement range (e.g., for measurement and reporting of phase measurement) including at least one of the following: one or more path IDs; one or more PRS resource IDs and/or one or more PRS beam IDs and/or one or more PRS resource set IDs; frequency indication; time indication; measurement range; EO information; measurement reference indication; expected sensing target information; measurement correction information; combinations of the same; or the like.

For example, one or more path IDs are provided. In one example, the WTRU 620 may be configured to perform phase measurements of only the indicated path. In one example, the WTRU 620 may receive at least one path ID or a range of one or more path IDs for phase measurement.

For example, one or more PRS resource IDs and/or one or more PRS beam IDs and/or one or more PRS resource set IDs are provided. In one example, the WTRU 620 may receive the measurement range based on the indicated one or more PRS resources, one or more beams and/or one or more resource sets and may perform the phase measurements only the indicated one or more resources or beams.

For example, frequency indication is provided. In one example, the WTRU 620 may receive an indication of at least one or a set of frequencies (e.g., in terms of Hertz (Hz), RE index, resource block (RB) index, PFL ID, BWP ID, or the like) where the WTRU 620 may perform the phase measurements. If the WTRU 620 receives a set of frequencies, the WTRU 620 may be configured to perform, process and/or report the measurements on all the indicated frequencies, or the WTRU 620 may select at least one or a combination of the frequency ranges.

In one example, if a phase measurement corresponds to measurements of more than one path, and/or DL PRS resource, and/or DL PRS beams and/or DL PRS resource set(s) and/or TRP(s), the WTRU 620 may be configured to perform the measurements within the same indicated frequencies for the measurements. For example, the WTRU 620 may be configured to measure the phase of a reference path with one frequency indication (e.g., RE index #1, PFL ID #1, or the like) and the phase of the sensing path with the same indication (e.g., RE index #1, PFL ID #1, or the like) while performing relative phase measurements.

In one example, the WTRU 620 may receive an indication to perform phase measurements on a specific frequency from a range of frequencies. For example, the WTRU 620 may receive an RB or PFL ID and may be configured to perform measurements on the center frequency.

For example, time indication is provided. In one example, the WTRU 620 may receive a time indication or a range of time (e.g., start time, stop time, or the like), e.g., in terms of absolute time (e.g., symbol index, slot index, frame index, subframe index), or a relative time (e.g., number of symbols, slots, frames, or subframes) with respect to a reference time), or the like where the WTRU 620 may perform the phase measurements.

For example, a measurement range is provided. FIG. 7 illustrates a plot 700 of a relative delay range indication for phase measurements. In one example, a WTRU 620 may receive an indication of a range of measurements (e.g., minimum and/or maximum measurement thresholds (e.g., RSRP, RSRPP, AoA, relative delay, Doppler shift, phase, or the like)), where the WTRU 620 may perform measurements and/or reporting on. In one example, the WTRU 620 may only perform the phase measurements within the indicated measurement range.

For example, the WTRU 620 may receive an indication of minimum and maximum relative delay ranges (e.g., with respect to a reference path, LoS path, or the like), as illustrated in FIG. 7, and the WTRU 620 may perform phase measurement only within the indicated delay range.

For example, the WTRU 620 may receive an indication of the minimum and/or maximum AoA range (e.g., with respect to a reference direction, e.g., absolute reference direction (e.g., global coordinate system (GCS), true north, or the like), relative reference direction (e.g., local coordinate system (LCS)), and the WTRU 620 may perform phase measurements only within the given AoA range.

In one example, the maximum and/or minimum measurement threshold may correspond to a threshold with respect to a relative expected measurement value. For example, the WTRU 620 may be configured with an AoA value and a maximum and/or minimum AoA threshold of X degrees. The WTRU 620 may determine the AoA range as X degrees higher and/or lower of the expected AoA value. For example, the maximum and minimum value would correspond to [expected AoA+X degrees, expected AoA−X degrees].

In one example, the WTRU 620 may receive the reference for the measurement range indication.

For example, the WTRU 620 may receive the reference for time based range indications (e.g., delay) based on absolute time such as system frame number 0 (SFN0) time, or relative time such as PRS transmission time, time of reception of n-th path, LoS path, or the like.

Also, for example, the WTRU 620 may receive the reference for angle range indications (e.g., AoA) based on absolute direction such as geographical north, GCS, or the like, or relative direction such as orientation, LCS, angle of an indicated path (e.g., LoS path), or the like.

Further, for example, the WTRU 620 may receive a reference corresponding to a path in other measurement occasion, e.g., N-th measurement occasion, previous measurement occasion, or the like.

In addition, for example, the reference may be the corresponding measurement associated with the indicated reference path. For example, the WTRU 620 may receive an expected measurement value, which is the measurement associated with the sensing path in the previous measurement occasion.

Moreover, for example, a reference may be indicated for one or more measurements, independently or together. For example, the reference for relative phase measurement and relative delay measurement may correspond to the phase and delay of the same path (e.g., first path).

For example, EO information is provided. In one example, the WTRU 620 may receive at least one of the following the assistance information of EOs: EO ID; EO type (e.g., EO type 1, EO type 2, vehicle, buildings, unmanned aerial vehicles (UAVs), or the like); EO size, e.g., categorial size (e.g., large, small, medium, 1, 2, or the like) or numerical size (e.g., [height, width, depth], e.g., in terms of meters, relative size compared to a reference object, or the like); EO material (e.g., concrete, metal, plastic, or the like); EO material properties (e.g., material conductivity, permittivity, or the like); EO radar cross section (e.g., in terms of decibels per square meter (dBsm)); EO location, e.g., in terms of absolute location, relative location with respect to the TRP, or the like; EO location error and/or uncertainty (e.g., in terms of meters squared (m²)); EO mobility information, e.g., mobile, static, or the like; EO velocity, e.g., in terms of meters per second (m/sec); EO acceleration, e.g., in terms of meters per seconds squared (m/sec²); at least one of the reference measurements associated with EOs; validity duration (e.g., in terms of absolute time units such as seconds, symbol index, slot index, frame index, subframe index, or relative time units such as number of symbols and/or slots and/or frames and/or subframes or seconds with respect to a reference time); combinations of the same; or the like.

For example, the at least one of the reference measurements associated with EOs includes at least one of the following: reference channel amplitude information for the EO; reference phase information for the EO (e.g., associated with one or more indicated carrier frequencies, e.g., center frequency of a PFL); reference delay information of the EO (e.g., relative delay information, e.g., with reference to the LoS path, reference time, or the like); reference AoA information of the EO (e.g., with respect to a global reference (e.g., true north, GCS, or the like), relative reference (e.g., TRP location, LCS, or the like)); reference Doppler shift information of the EO; reference RSRPP measurement information of the EO (e.g., in terms of decibel milliwatts (dBm), Watts (W), absolute RSRPP or relative RSRPP with respect the RSRPP of a path, or the like); reference frequencies associated with the reference measurements; uncertainties associated with one or more of the reference measurements; reference EO measurement condition associated with the reference measurements; combinations of the same; or the like.

For example, the reference EO measurement condition associated with the reference measurements includes at least one of the following: reference measurement location (e.g., location of the receiver) associated with the reference measurements; reference orientation (e.g., of the receiver); reference receiver (e.g., sensing receiver that performed the measurements) antenna properties associated with the reference measurements; one or more reference PRS IDs (e.g., PRS resource ID, PRS beam ID, PRS resource set ID, or the like) associated with the measurements; timestamp associated with the reference measurements, or the like; combinations of the same; or the like.

For example, the reference receiver (e.g., sensing receiver that performed the measurements) antenna properties associated with the reference measurements include at least one of the following: phase errors of the antenna, phase error groups (e.g., PEG) of the antennas, phase errors associated with the PEGs, phase synchronization errors associated with the receiver antenna, or the like; number of antenna elements associated with the receiver antenna, downtilt of the antenna associated the receiver antenna; reference point on the receiver antenna including at least one of the antenna phase center, antenna connector, or the like; combinations of the same; or the like.

For example, a measurement reference indication is provided. In one example, the WTRU 620 may receive an indication of the measurement reference for phase measurements from the network. The indication may be at least one of the following: reference phase value (e.g., in terms of degrees, radians, e.g., 0 radians, or the like); reference path (e.g., LoS path, first path, path ID, or the like); reference TRP (e.g., in terms of cell ID, TRP ID, sector ID, or the like); reference measurement range indication, which may indicate the reference for phase measurements; reference associated with other sensing measurements (e.g., reference (e.g., reference path) associated with the relative delay measurement, AoA measurements, or the like); reference EO indication (e.g., among one of the (pre)configured EOs) (e.g., EO ID, EO location, or the like); reference TRP ID, PRS resource ID, PRS beam ID, PRS resource set ID, or the like; combinations of the same; or the like.

For example, reference measurement range indication, which may indicate the reference for phase measurements, includes at least one of the following: reference RSRPP threshold (e.g., reference RSRPP range); reference AoA (e.g., reference AoA range); reference relative delay (e.g., with respect to an indicated reference, e.g., LoS path, e.g., reference relative delay range); reference location; combinations of the same; or the like.

For example, expected sensing target information is provided. In one example, the WTRU 620 may receive an indication from the network with the expected (and/or intended) sensing target information for sensing including at least one of the assistance information described for EOs, by replacing the EO with the expected sensing target. For example, the WTRU 620 may receive at least one of the following: expected sensing target ID; expected sensing target type (e.g., vehicle, buildings, UAVs, or the like); expected sensing target size, e.g., categorial size (e.g., large, small, medium, 1, 2, or the like) or numerical size (e.g., [height, width, depth], e.g., in terms of meters, relative size compared to a reference object, or the like) and so on; combinations of the same; or the like.

In one example, the WTRU 620 may receive an indication of an EO information (e.g., EO ID) in the expected sensing target information, if the sensing target is same as the one of the (pre)configured EO.

For example, measurement correction information is provided. In one example, the WTRU 620 may receive at least one of the following indications of phase error information: TRP phase bias; difference of phase biases between one or more TRPs (e.g., reference TRP and a second TRP); measurement offsets (e.g., relative delay offset, relative phase offset, or the like) between LoS path and one or more reference paths, EO paths, or the like; combinations of the same; or the like.

In certain representative embodiments, measurement procedures are provided. The WTRU 620 may receive the configured PRS resources and may determine to perform measurements (e.g., phase measurements) for sensing. For example, the measurement procedures include at least one of the following: phase measurement within a measurement window, phase measurement within a measurement range, phase measurement in indicated frequencies, phase measurement in an indicated time, reference for phase measurement, phase measurements with other measurements, sensing path determination, phase measurement uncertainty, combinations of the same, or the like.

For example, phase measurement within the measurement window is provided. In one example, the WTRU 620 may perform the phase measurements only within a measurement window. The WTRU 620 may receive indication to activate the measurement window. In another example, the WTRU 620 may determine to activate or request the network to activate the measurement window based on the at least one or more of the conditions described as trigger conditions to initiate or request the network to initiate the phase measurement.

In one example, the configured measurement window may be a simultaneous measurement window, where more than one WTRUs may perform the phase measurements.

For example, phase measurement within a measurement range is provided. In another example, the WTRU 620 may perform the phase measurements only within the indicated measurement range.

The WTRU 620 may be configured with one or more path IDs to perform measurements on and the WTRU 620 may determine to only measure and/or process and/or report the phase of the one or more path IDs.

The WTRU 620 may be configured with one or more TRP IDs, one or more PRS resource IDs, one or more PRS beam IDs, and one or more PRS resource set IDs to perform measurements on. The WTRU 620 may determine to only measure, process, and/or report the phase from the measurements associated with the indicated TRPs and resources.

The WTRU 620 may be configured with a measurement range to perform measurements on. For example, the WTRU 620 may receive an indication to perform the measurements with a minimum relative delay range of X ms (e.g., with respect to the first path). The WTRU 620 may only perform the measurement only after the indicated X ms delay has elapsed after reception of the first path. For example, the WTRU 620 may receive an indication to perform measurements within the indicated maximum and minimum AoA range (e.g., Xmin degrees and Xmax degrees with respect to a reference direction of true North). The WTRU 620 may perform the measurement corresponding to the paths that arrive from within the indicated angle range. In another example, the WTRU 620 may set its receive beam direction based on indicated measurement range (e.g., AoA range).

In one example, the WTRU 620 may receive an indication of expected measurement and a threshold, e.g., a minimum threshold, a maximum threshold, or the like. The WTRU 620 may perform measurements within the indicated threshold value of the indicated expected value. For example, the WTRU 620 may be configured with an expected AoA and a minimum and maximum threshold of X degrees. The WTRU 620 may perform measurements within X degrees of the expected AoA.

In one example, the WTRU 620 may measure a reference path even if the reference (e.g., reference path) is outside of the measurement range. In another example, the WTRU 620 may be configured to determine a new reference if the reference (e.g., reference path) is outside of the measurement range. In another example, the WTRU 620 may be configured with a reference measurement range, which may be disjointed with the indicated measurement range in one example, and the WTRU 620 may measure the path within this reference measurement range to determine to the reference.

For example, phase measurement in the indicated frequencies is provided. For example, the WTRU 620 may be configured with one or more frequencies to perform the measurements on. In one example, the WTRU 620 may receive an indication of a set of frequencies or a frequency range in terms of at least one of the RE index, RB index, PFL ID, BWP ID, or the like, from the network to perform the phase measurements on.

In one example, the WTRU 620 may determine number and/or the carrier frequencies to perform measurement on from the indicated set of frequencies or frequency ranges based on at least one of the following: the configured QoS requirement (e.g., accuracy) for sensing; the configured PRS bandwidth; the number of samples the WTRU 620 is capable of processing (e.g., performing FFT); the number of multipath components in the channel; PRS resource configuration (e.g., density of PRS resources, or the like); the measurements (e.g., RSRP), LoS and/or NLoS ID associated with the TRP, PRS resource, PRS beam, PRS resource set; indication from the network; combinations of the same; or the like.

The WTRU 620 may determine one number of frequencies or one set of frequencies if at least one of the above-mentioned conditions is below a threshold and another if it is above a threshold.

In one example, the WTRU 620 may determine to perform phase measurements on the reference frequencies indicated by the network. In another example, the WTRU 620 may implicitly determine the frequencies to perform phase measurements on based on at least one of the following: frequencies associated with the reference (e.g., phase) measurements of an EO; frequencies associated with the reference (e.g., phase) measurement of the expected sensing target; frequencies indicated with or more indications or assistance information, or the like; combinations of the same; or the like.

For example, phase measurement in the indicated time is provided. In one example, the WTRU 620 may be configured to perform the phase measurements in the indicated time resources from the network and the WTRU 620 may perform the measurements only in the indicated resources.

For example, a reference for phase measurement is provided. In one example, the WTRU 620 may be configured with a reference for the phase measurement. In another example, the WTRU 620 may determine and/or report the reference for the phase measurement based on at least one of the following: a reference phase measurement associated one of the paths, a reference phase, a reference TRP, combinations of the same, or the like.

For example, regarding the reference phase measurement associated with one of the paths, the path may be at least one of the following: path indicated by the network (e.g., first path, LoS path, or the like); N-th path, LoS path, or the like; path associated at least one of the indicated EOs; path associated with the measurement within the indicated reference measurement range (e.g., reference RSRPP range, reference AoA range, reference relative delay range, or the like); path with measurement (e.g., RSRPP, relative delay, AoA, or the like) above a (pre)configured threshold; path associated with the reference is measured with the indicated reference TRP ID, reference PRS resource, PRS beam and/or PRS resource set; path with measurements corresponding to the reflections from a reference location; path with measurement difference (e.g., RSRPP difference, relative delay difference, AoA difference) compared to the sensing path below or above a (pre)configured threshold; path with the uncertainty associated one or more associated measurements (e.g., RSRPP, delay, relative delay with respect to a reference, or the like) below a (pre)configured threshold, or the like; path associated with a (e.g., reference) TRP; combinations of the same; or the like.

Also, for example, the reference phase is based on at least one of the following: a default reference phase, e.g., 0 degree; the indicated phase associated with the reference EO; the phase value corresponding to the distance between the TRP, target object and the WTRU 620, or the distance between the TRP and WTRU 620; a reference phase value indicated by the network; the phase of the transmitted PRS resource (e.g., by a TRP), or the like; indication from the network; combinations of the same; or the like.

Further, for example, the reference TRP is based on at least one of the following: indication from network; the TRP with the measurements (e.g., RSRP) above a (pre)configured threshold; the TRP with distance to the WTRU 620 below or above a (pre)configured threshold; the TRP associated with the serving cell of the WTRU 620, or the like; combinations of the same; or the like.

In one example, the WTRU 620 may be configured to determine and/or perform measurements and/or report the phase measurements based on the reference for the phase measurements as noted herein.

For example, phase measurements with other measurements are provided. In one example, the WTRU 620 may be configured to perform and/or report perform the phase measurement with other measurements (e.g., relative delay measurements, AoA measurements, or the like). In one example, the WTRU 620 may perform phase measurements with at least one of the following measurements: relative delay measurements, RSTD measurements per path, WTRU Rx-Tx time difference per path, AoA per path measurements, Doppler shift measurements, RSRPP measurements, combinations of the same, or the like.

In one example, the above listed measurement may correspond to the one or more paths, one or more TRPs, one or more PRS resources, PRS beams, one or more PRS resource sets, or the like.

In one example, the WTRU 620 may determine that the references associated with the phase measurements and other measurements may be the same. The WTRU 620 may be configured with the phase reference as the reference for another measurement quantity, for instance the reference path for relative delay measurements.

In one example, the WTRU 620 may perform the phase measurements with more than one PRS resources or beams. In one example, the path measurements (e.g., associated with the resource, beam) may not include the (e.g., configured) reference path for relative phase measurement.

FIG. 8 illustrates measurement 800 with respect to two different PRS resources. In one example, the sensing path and the reference path may correspond to the measurements from two different beams or one or more resources, as illustrated in FIG. 8. In such case, as the reference time (e.g., transmission time) of the two beams or resources may be different, the measurements, e.g., relative delay measurement, may consist of additional offset.

In such case, a WTRU 820, when establishing a sensing path with a sensing target 830, may receive an indication from a network (e.g., TRP 810) to compensate for additional measurement offset. For example, the WTRU 820 may receive the delay offset between the transmission times of the two resources and/or two beams and/or two TRPs. The WTRU 820 may determine the relative delay measurement by compensating or removing or subtracting this offset. In another example, the WTRU 820 may report the relative delay measurements without compensating for the offset but indicating that they correspond to two different resources or beams (e.g., via resource IDs, resource set IDs, beam IDs, timestamp associated with each measurement, or the like).

In another example, the WTRU 820 may determine to change the reference path to one of the paths measured with the same PRS resource or beam. In one example, the WTRU 820 may reselect the reference path based on at least one of the before mentioned conditions. For example, if the WTRU 820 is configured with paths associated with the reference EOs by the network, the WTRU 820 may select the path as the reference if the path is measured with the same beam or resource. In one example, the WTRU 820 may be configured with the measurement offsets (e.g., relative delays, AoA, or the like) of one or more paths with the configured reference path (e.g., LoS path). The WTRU 820 may select the path with the configured measurement offset with respect to the reference path if the path is measured with the same resource or beam as the sensing path. For example, as illustrated in FIG. 8, the WTRU 820 may measure the relative path delay with respect to the EO path instead of LoS path and compensate the relative delay with the offset of delays between LoS and EO path. In one example, the WTRU 820 may determine this delay offset as the difference between transmission times of PRS resource #1 and PRS resource #2.

In one example, the WTRU 820 may report the phase with either the originally indicated reference or newly determined reference path. In one example, if the WTRU 820 measures the phase measurements (e.g., relative RSCP of the sensing path) with the newly determined or indicated reference path, the WTRU 820 may also measure and report the phase of the newly determined reference path with respect to the originally indicated reference path.

In another example, the WTRU 820 may report that the reference path is not measured or contained within the same resource or beam consisting of the sensing path to the network and terminate the phase measurement procedure.

For example, sensing path determination is provided. In one example, the WTRU 820 may be configured with a sensing path from the network, where the sensing path may be at least one of the paths measured by the WTRU 820.

In another example, the WTRU 820 may determine the path corresponding to the sensing target (e.g., the sensing path), to perform the phase measurements, based on at least one of the following: one or more of the (e.g., configured) paths (e.g., one or more path IDs); one or more paths with the measurements within the (e.g., configured) measurement range; one or more paths with measurements (e.g., RSRPP, Doppler shift, or the like) above or below a (pre)configured threshold; one or more paths not corresponding to the (e.g., configured) EO paths, or measurements associated with the EO paths; one or more of the paths associated with the (e.g., configured) TRP and/or PRS resource and/or PRS beam and/or PRS resource; one or more of the paths with the measured uncertainty (e.g., delay uncertainty, phase measurement uncertainty, AoA measurement uncertainty) above or below a (pre)configured threshold; one or more of the paths corresponding to the PRS resource or PRS beam or PRS resource set with (e.g., configured) reference path (e.g., first arrival path, LoS path, or the like) in the measurement; one or more of the paths corresponding to the PRS resource or PRS beam or PRS resource set with the measurements (e.g., RSRP) above a (pre)configured threshold; combinations of the same; or the like.

In one example, if the WTRU 820 measurement of more than one of the paths for phase measurements are based on the above criteria, the WTRU 820 may determine a path as the sensing path if the path has at least one of the following: highest or lowest measurement value (e.g., highest RSRPP, lowest Doppler shift, or the like); highest or lowest measurement uncertainty, or the like; combinations of the same; or the like.

In one example, the WTRU 820 may perform the phase measurement based on the measured phase of the sensing target relative to (e.g., configured or determined) reference.

In one example, the path corresponding to the sensing target may be measured with the RS corresponding to more than one beam IDs, and the WTRU 820 may associate the path and/or at least one of the associated measurements (e.g., phase measurements, AoA, relative delay, or the like) between the beams. The WTRU 820 may perform the associations of the measurements based on at least one of the following: the difference between the at least one of the path measurements (e.g., relative delay, RSRPP, AoA, Doppler shift measurement, or the like) corresponding to two measured paths associated with two RS beams is below a (pre)configured threshold; the two RS beams spatially overlap with each other, or the like; combinations of the same; or the like.

In another example, the WTRU 820 may perform the phase measurements with RSs from more than one TRPs. The WTRU 820 may associate the path and/or at least one of the associated measurements (e.g., phase measurements, AoA, relative delay, or the like) corresponding to the TRPs based on at least one of the following: the difference between the at least one of the path measurements (e.g., AoA, Doppler shift measurement, or the like) corresponding to two measured paths associated with two TRPs is below a (pre)configured threshold; the two beams associated with the TRPs spatially overlap with each other; combinations of the same; or the like.

In one example, the WTRU 820 may be configured to perform and/or report RSCPD per path measurements or RSTD per path measurements between the path measurements of the associated paths (e.g., between the reference TRP, and the second TRP).

For example, phase measurement uncertainty is provided. In one example, the WTRU 820 may be configured to determine and/or report the measurement errors or uncertainty, or phase resolution associated with the phase measurements. The WTRU 820 may determine the uncertainty based on at least one of the following: TRP phase bias errors; WTRU 820 phase bias error; phase synchronization error between the TRP and the WTRU 820; measurement uncertainty (e.g., based on measurement statistics such as variance) associated with the phase measurements of one or more paths (e.g., sensing path, reference path, LoS path, or the like); measurements (e.g., RSRPP) associated with one or more measured paths (e.g., sensing path, reference path); measurements (e.g., RSRP, SINR, or the like) associated with one or more measured PRS resources; PRS bandwidth; PRS configuration associated with the measurements (e.g., PRS density, comb size, or the like); phase resolution; number of samples (e.g., time and/or frequency) associated with the measurement; number of measured frequencies associated with the phase measurement; measurement (e.g., relative delay, AoA, doppler shift, RSRPP, or the like) uncertainty associated with the paths (e.g., sensing path, reference path, or the like); phase errors associated with the WTRU 820 antenna elements (e.g., error associated with one or more phase error groups), uncertainty associated with WTRU 820 location, or the like; combinations of the same; or the like.

In one example, the measurement uncertainty for the phase measurement may be determined based on the phase measurement quantity and/or the reference associated with the phase measurements.

For example, the WTRU 820 may perform phase difference measurements between two phase quantities, e.g., associated with two path of different beam or a different TRP. If the WTRU 820 performs the phase difference measurement between different paths from the same RS beam and the same TRP, the WTRU 820 may determine that the TRP phase bias errors and WTRU 820 phase bias errors are eliminated and may not use it to determine the phase measurement uncertainty.

If the WTRU 820 performs the phase difference measurement between different paths from different RS beams from the same TRP, the WTRU 820 may determine that the TRP phase bias errors are eliminated. The WTRU 820 may also determine that the (e.g., at least non time varying) WTRU 820 phase bias errors are eliminated and may not use it to determine the phase measurement uncertainty.

If the WTRU 820 performs the phase difference measurement between different paths from different RS beams from different TRPs, the WTRU 820 may determine that the (e.g., at least non time varying) WTRU phase errors are eliminated and may not use it to determine the phase measurement uncertainty. However, the WTRU 820 may determine that uncertainty as a function of a difference of the TRP phase bias errors.

In one example, the WTRU 820 may determine phase bias errors of the TRP and/or the WTRU 820 may be specific to one or more antennas or groups of antennas. The WTRU 820 may determine that the group of antenna elements with similar phase bias error as a TRP or WTRU phase error group.

In certain representative embodiments, EO phase compensation is provided. For example, a general principle of phase addition due to multipath is provided. The WTRU 820 may receive and measure the transmitted reference signal where the signal may arrive as a reflection from one or more multipath components. These multipath components may comprise of one or more reflections from one or more scattering points in the environment such as the sensing targets, EOs, or the like.

If the multipath components are resolved (e.g., in delay domain), the WTRU 820 may be able to determine the phase measurements associated with different paths without ambiguity (e.g., corresponding only to the reflection object or target). However, if the phases are not resolved, the WTRU 820 may measure a signal containing the phase measurements associated with more than reflection paths or objects.

FIG. 9 depicts uncertainty of delay measurement 900 as a trigger condition for EO phase compensation. For example, as illustrated in FIG. 9, a WTRU 920 may receive and measure multiple paths to a TRP 910, e.g., LoS path (e.g., Path 1 in FIG. 9), and paths from a target object 940 and at least one EO 930 (e.g., Path 2 in FIG. 9). Due to the time resolution, the WTRU 920 may measure the relative delay of the multipath components as a single cluster (e.g., as indicated by the curve labeled “Path 2” in the RSRPP, delay path profile, as seen in FIG. 9.

Due to the path resolution, when measuring the phase associated with Path 2, the WTRU 920 may measure a combination of paths from the target object 940 and the EO 930. For example, if the amplitude associated and phase of the channel response associated with the target object 940 is given by the following terms (9):

$${a}_{0} {e}^{- j {ωϕ}_{0}} \qquad ( 9 )$$

and the channel response of the other paths from the EOs is given the following terms (10) and (11):

$${a}_{1} {e}^{- j {ωϕ}_{1}} \qquad ( 10 )$$

$${a}_{2} {e}^{- j {ωϕ}_{2}} \qquad ( 11 )$$

in baseband, the WTRU 920 may receive the signal as the following equation (12):

$$s ( t ) = {a}_{0} {e}^{- j {ωϕ}_{0}} + {a}_{1} {e}^{- j {ωϕ}_{1}} + {a}_{2} {e}^{- j {ωϕ}_{2}} \qquad ( 12 )$$

In the above example, the signal measurement corresponds to measurement from the frequency component ω.

The WTRU 920 may measure the phase of the received signal as the following equation (13):

$$∠ s ( t ) = {tan}^{- 1} ( \frac{- {a}_{0} sin ( {ωϕ}_{0} ) - {a}_{1} sin ( {ωϕ}_{1} ) - {a}_{2} sin ( {ωϕ}_{2} )}{{a}_{0} cos ( {ωϕ}_{0} ) + {a}_{1} cos ( {ωϕ}_{1} ) + {a}_{2} cos ( {ωϕ}_{2} )} ) \qquad ( 13 )$$

In equation (13), the measured phase contains the amplitude and phase components of the multipath (e.g., EOs, such as EO 930). Hence, the WTRU 920 may be unable to capture the measured phase associated with only the target object 940.

For example, a request for phase compensation is provided. In one example, the WTRU 920 may be configured with the reference EO information in the vicinity, and the WTRU 920 may be configured to may determine to compensate for the additional phase component due to the multipath reflections.

In another example, the WTRU 920 may determine to request reference EO information (e.g., for phase compensation) or phase compensation information and/or compensate the phase from the network based on at least one of the following conditions: the measured PRS bandwidth is below a (pre)configured threshold; the number of carrier frequency components for phase measurements is below a (pre)configured threshold; the uncertainty of a path (e.g., LoS path, sensing path, reference path) is above a (pre)configured threshold; the measurements (e.g., RSRP, SINR, or the like) of the PRS resource or PRS beam or PRS resource set associated with the paths (e.g., sensing path, reference path, or the like) for phase measurement is below a (pre)configured threshold; the number of multipath components associated with the measurements of the PRS resource is above a (pre)configured threshold; the delay spread associated with the measurements of the PRS resource is above a (pre)configured threshold, or the like; combinations of the same; or the like.

In one example, the WTRU 920 may request for one or more phase compensation values from the network, where the request includes at least one of the WTRU location, WTRU velocity, path measurements (e.g., associated with the sensing path), references associated with the path measurements, or the like.

For example, phase compensation based on configurations is provided. In one example, the WTRU 920 may receive the phase and/or amplitude for compensation and may apply the phase compensation to the path measurement.

In one example, the WTRU 920 may receive, from the network, details related to phase compensation (e.g., expected phase offset at the transmitter at the network, expected phase offset at the UE, expected phase drift, phase drift rate, or the like) in assistance information. The WTRU 920 may receive, from the network, assistance information in addition to PRS configurations. The WTRU 920 may receive, from the network, details related to phase compensation based on the request from the UE.

In one example, the WTRU 920 may determine to apply phase compensation to the measurements. The WTRU 920 may indicate to the network that phase compensation has been applied to measurements (e.g., phase measurements). The WTRU 920 may indicate or report to the network the phase compensation values estimated by the network (e.g., estimated phase drift).

In another example, the WTRU 920 may receive an indication of a configured reference EO (e.g., via EO ID, reference measurements associated with EO 930, or the like). The WTRU 920 may determine to use the (e.g., configured) amplitude and/or phase associated with the indicated EO 930.

In another example, the WTRU 920 may receive a set of reference EO information (e.g., reference amplitude and/or phase information) as assistance information, and the WTRU 920 may be configured to determine amplitude and/or one or more phase measurements the WTRU 920 may perform compensation with.

In one example, the WTRU 920 may be configured to determine one or more EOs influencing the sensing path measurements (e.g., time delay measurements, phase measurements, or the like). The WTRU 920 may determine the EOs influencing the measurements based on at least one of the following conditions: the difference between at least one or more of the measurements of the sensing path and at least one reference measurement of an EO is below a (pre)configured threshold; the references for the sensing path measurements and that associated with the reference measurement of the EO are the same; the measurement condition of the WTRU 920 (e.g., WTRU location, WTRU velocity, WTRU orientation, or the like) correspond to the measurement conditions indicated with the configured EO information; the measurement time of the sensing path measurement is within the validity time duration associated with the EO; or the like.

For example, phase compensation based on WTRU measurements is provided. In another example, the WTRU 920 may be configured by the network to perform the reference measurements (e.g., the reference phase and/or amplitude of the path(s) associated with one or more EO 930, or the like).

For example, the WTRU 920 may receive an indication of activation of a measurement window for reference measurement (e.g., amplitude, phase, RSRPP, of the EO 930, or the like) for compensation.

In one example, the WTRU 920 may receive an indication of a reference measurement range for EO determination. In another example, the WTRU 920 may determine the measurement range based on the sensing path (e.g., measurements associated with the sensing path).

In one example, the WTRU 920 may receive PRS configurations for one or more resources for reference measurements.

The WTRU 920 may determine that a measurement (e.g., performed within the reference range) is a reference measurement of an EO 930 for phase compensation based on at least one of the following conditions: the measured RSRPP of the measured path is above a (pre)configured threshold; the difference between the measurements (e.g., RSRPP, Doppler shift, phase, or the like) of the measured path and the sensing path is below or above a (pre)configured threshold; the difference between the measurements (e.g., AoA, relative delay) of the measured path and that of the sensing path is below a (pre)configured threshold; the uncertainty of the measurements (e.g., relative delay, AoA, or the like) of the measured path is below a (pre)configured threshold; the PRS bandwidth is above a (pre)configured threshold, or the like; combinations of the same; or the like.

In one example, the WTRU 920 may be configured to activate the measurement window or the procedure for phase and/or amplitude measurement for compensation after a (pre)configured amount duration of the sensing path measurement. In one example, this duration may be determined by the WTRU 920 based on: the PRS bandwidth; the determined velocity or the measured Doppler shift of the target object 940; the measurements of the path (e.g., RSRPP, AoA, or the like) of the path associated with the target object 940; the difference in measurement (e.g., RSRPP, AoA, or the like) associated with the target path in two measurement occasions; indication from the network, or the like; combinations of the same; or the like.

In one example, the WTRU 920 may determine the phase associated with the target object 940 by compensating the measured phase with the configured and/or determined phase and/or amplitude associated with the multipath component, e.g., EO path.

For example, the WTRU 920 may determine the compensated phase, φ₀, by solving the following equation (14):

$$tan ( ∠ s ( t ) ) = \frac{- {a}_{0} sin ( {ωϕ}_{0} ) - {a}_{1} sin ( {ωϕ}_{1} ) - {a}_{2} sin ( {ωϕ}_{2} )}{{a}_{0} cos ( {ωϕ}_{0} ) + {a}_{1} cos ( {ωϕ}_{1} ) + {a}_{2} cos ( {ωϕ}_{2} )} \qquad ( 14 )$$

In the above equation the WTRU 920 may input the amplitude (e.g., a₁, a₂, . . . etc.) and phases (e.g., φ₁, φ₂, . . . etc.) of the relevant EOs or the multipath components.

For example, phase measurement based on EO validity duration is provided. In one example, the WTRU 920 may be configured with EO assistance information consisting of at least one of more of the validity duration associated with one or more EOs. In one example, the WTRU 920 may receive the validity duration in terms of time duration units (e.g., seconds, or number of slots, symbols, frames or subframes, or the like). In one example, the duration may be relative to a reference time (e.g., the time instance the WTRU 920 receives indication of validity duration). In another example, the validity duration may be an absolute time such as in terms of UTC time, GNSS time, locally defined absolute time (e.g., LTE or NR Time), or the like.

In one example, the WTRU 920 may be configured to perform phase based sensing and may determine the presence of one or more EOs in the path measurement. In another example, the WTRU 920 may receive an indication of one or more EOs that may be associated with the path measurements.

In one example, the WTRU 920 may determine that the measurement time instance is approaching the expiry of the validity duration of at least one or more of the EOs. In such case, the WTRU 920 may be configured to perform the measurements and/or reporting for the phase measurement after the validity duration has expired. For example, if the indicated validity time for an EO to be compensated is T1 from a reference time (e.g., start time of the measurement window) and a measurement occasion for phase measurement is T2 from the reference time, the WTRU 920 may determine to perform the measurement after T1 time if the difference between T2 and T1 is below a (pre)configured threshold. The WTRU 920 may receive an indication to only perform measurement(s) or report the measurements only corresponding to occasions after the validity duration of the EO has expired.

In certain representative embodiments, integer determination for carrier-phase based sensing is provided. For example, the integer determination for carrier-phase based sensing includes at least one of integer ambiguity based on non-phase sensing measurements, integer ambiguity based frequency measurements, combinations of the same, or the like.

For example, integer ambiguity based on non-phase sensing measurements is provided. Phase measurements can correspond to the delay duration between two entities (e.g., transmitter and the receiver). However, as phase measurements corresponding to the wavelengths are 2π modulo values, determining the corresponding delay or relative delay measurements with only phase measurements presents an ambiguity as the phase measurements alone do not capture the integer number of wavelengths.

In one example, the WTRU 920 may be configured to determine and/or report the integer ambiguity corresponding to the phase measurements.

In one example, the WTRU 920 may determine the integer value for the relative RSCP measurements of the sensing path relative to the phase of a reference path based on the relative delay measurement of the sensing path relative to the reference path. In one example, the references for both the phase measurements and the relative measurements for the sensing path may be required to be the same. If the references are not the same, the WTRU 920 may additionally use and/or report the offset for the relative RSCP or delay measurements to determine the integer ambiguity.

In one example, the WTRU 920 may determine the integer value for the RSCP measurement per path (e.g., for the sensing path) based on the delay corresponding to the sensing path. In one example, the WTRU 920 may determine the delay corresponding to the sensing path based on the RTT measurement per path corresponding to the sensing path. For example, the WTRU 920 may receive the PRS and transmit an uplink RS (SRSp) subsequently to determine the RTT corresponding to the sensing path. In one example, the WTRU 920 may measure and report the WTRU Rx-Tx time difference per path where the time difference corresponds to the time duration between the WTRU reception of the sensing path of the DL-PRS and the WTRU transmission of the uplink RS (SRSp).

In one example, the WTRU 920 may determine the integer value for RSCPD measurement for the sensing path based on the RSTD measurement associated with the sensing path. For example, the RSTD measurement for the sensing path may correspond to the time duration between the reception of the reference path of the reference TRP and the sensing path of the second TRP. In one example, the reference path of the reference TRP may be associated with the sensing path of the second TRP. In another example, the reference path and the sensing path in the above examples, for the RSCPD and RSTD measurements, may correspond to the measurements from the same TRP (e.g., reference TRP).

In one example, the WTRU 920 may determine the integer ambiguity value for RSCP measurements at a first antenna elements and the second antenna element based on the distance between the first and the second antenna elements and the measured direction of arrival (e.g., AoA) of the sensing path.

For example, integer ambiguity based on frequency measurements are provided. In another example, the WTRU 920 may determine the integer ambiguity based on the phase measurements of more than one frequency. For example, the WTRU 920 may measure the phase of the sensing path with more than one carrier or frequency component. The WTRU 920 may combine the phase measurements of the two carriers, creating a phase measurement with a virtual wavelength much higher than that of the measuring carriers. By limiting the search space of the integers, the WTRU 920 may determine the ambiguity.

The WTRU 920 may be configured to measure and/or report at least one of the following measurements with the phase measurements to resolve integer ambiguity: relative delay measurements (e.g., of the sensing path, relative to the reference path); WTRU Rx-Tx time difference for the sensing path; RSTD of the sensing path; AoA of the sensing path; phase measurement corresponding to more than one frequency resources (e.g., RE index, RB index, subcarrier frequency, or the like); determined integer value (e.g., for the sensing path); determined reference for integer value (e.g., reference path); combinations of the same; or the like. For a determined reference for integer value, for example, if the WTRU 920 determines the integer ambiguity based on relative delay measurements of the sensing path with respect to a reference path which is the LoS path, the WTRU 920 may determine the integer value corresponding to the difference between the sensing and the reference path. The WTRU 920 may report this difference as an integer value. In another example, the WTRU 920 may determine the integer value of the sensing path associated with the delay duration between the transmission and reception of the reference signal associated with the sensing path based on (e.g., sum of) the distance between the TRP and the WTRU 920 and the determined integer value for the sensing path relative to the reference path.

In certain representative embodiments, WTRU based object positioning and material determination are provided. For example, the WTRU based object positioning and material determination includes at least one of phase correction due to sensing target material, sensing target location determination, sensing target material determination, combinations of the same, or the like.

For example, phase correction due to sensing target material is provided. In one example, the measured phase after reflection from the sensing target (in addition to the delay duration between the TRP, sensing target, and the WTRU 920) may be shifted due at least one of the following: material of the target object 940 (e.g., concrete); AoA of the received signal reflected from the target object 940; AoD if the transmitted signal reflected from the object; measured frequency component (e.g., carrier frequency) or the like; combinations of the same; or the like.

For example, if the measured phase is φ₀, the WTRU 920 may determine that the phase consists of two components, one associated with the duration between TRP, sensing target and the WTRU 920 and another associated with the object type. For example, e^{-jωφ}^{₀}=e^{-jωφ}^{_{delay}}^{φ}^{_{object}}. The WTRU 920 may be configured to determine the φ^{-jωφ}^{_{object}} and compensate to determine the φ_{delay} to determine the target location.

In one example, the WTRU 920 may be configured to correct the phase measurement after reflection from an object. In one example, the WTRU 920 may be configured with the phase correction factor to compensate for the reflection through a target object 940.

In another example, the WTRU 920 may be configured with the expected sensing target, associated set of values (e.g., table of values, function mapping the parameters to the phase value, or the like) for phase correction, associated with the expected target objects (e.g., UAV, vehicles, or the like), associated RCS values, object types, materials (e.g., wood, steel, or the like), and the other properties that may cause phase shift due to reflection, and the WTRU 920 may determine the phase correction value.

The WTRU 920 may determine the phase correction value based on at least one of the following examples. In one example, the WTRU 920 may determine the sensing target object 940 (or the material type, size of the target, or the like) based on sensing path measurements. For example, the WTRU 920 may determine the RCS of the object based on the measured RSRPP, and the WTRU 920 may determine the object and the corresponding phase correction value. For example, the WTRU 920 may determine the sensing target, and hence the phase correction value, based on the measured Doppler shift values.

In another example, the WTRU 920 may be configured with a reference sensing target associated with different locations, and the WTRU 920 may determine the sensing target, and hence the phase correction value, based on its location. For example, if the WTRU 920 is located in a vehicle on a highway, the WTRU 920 may determine that the sensing target associated with the sensing path is a vehicle and use corresponding phase correction.

For example, a sensing target location determination is provided. In one example, the WTRU 920 may be configured by the network to determine the location of the object based on at least phase measurements of the sensing path.

In one example, the phase measurement may be at least one of compensated phase measurement due to multipath components, corrected phase measurement values due to different material types, or just the measured phase values without compensation or correction.

In one example, the WTRU 920 may determine the location based on the configured sensing methods with phase measurement. For example, the delay of the sensing path may consist of the integer ambiguity and the additional component based on phase measurements.

In one example, the WTRU 920 may measure the phase measurements corresponding to the WTRU 920 location. The WTRU 920 may determine that the phase measurements do not correspond to the delay between the TRP, and the WTRU 920 and may determine that the sensing target or the sensing path may be close to the WTRU 920 location. In such case, the WTRU 920 may determine that the object location is the same as the WTRU 920 location and report the event and the WTRU 920 location to the network.

In one example, the WTRU 920 may receive an offset (e.g., phase difference bias offset between TRPs) to apply to the phase measurements (e.g., RSCPD measurements for the sensing path) that the WTRU 920 may apply to the measurements. In another example, the WTRU 920 may receive a reference measurement (e.g., RSCPD) from the network (e.g., from the PRU) associated with the sensing path, with which the WTRU 920 may perform double differentiation to remove the TRP phase bias. The WTRU 920 may receive at least one of the following from the network or the PRU: phase measurements associated with one or more paths (e.g., RSCPD per path measurements for the sensing path); measurements (e.g., relative delay, RSRPP, or the like) associated with one or more paths (e.g., sensing path); references (e.g., reference path, reference TRP, or the like) associated with the phase measurements, measurements; timestamp of the measurements (e.g., in terms of symbol index, slot index, frame index, subframe index, or the like); PRU location; PRS resource ID, PRS beam ID, PRS resource set ID associated with the measurement; measurement uncertainty (e.g., phase measurement uncertainty); LoS/NLoS ID of the PRU measurements, or the like; combinations of the same; or the like.

The WTRU 920 may determine a location of the object based on the WTRU 920 measurements and the indicated measurements from the network.

For example, sensing target material determination is provided. In one example, the WTRU 920 may be configured to determine the material of a sensing target. The WTRU 920 may be configured with a location of the expected target object 940. The WTRU 920 may determine the phase correction factor associated with the object material by correcting the phase change due to the delay between TRP, target, and the object based on the expected object location.

In one example, the WTRU 920 may determine a phase distribution due to the object material properties and determine the object or the object material based on the distribution. For example, the WTRU 920 may be configured with the reference phase value due to object material properties as an assistance information. The WTRU 920 may determine the object material based on the likelihood based on the distribution and the configured reference phase values of expected target objects (e.g., reference object types, reference materials, or the like).

In another example, the WTRU 920 may determine the object material based on the amplitude of the channel response of associated with the target. For example, the WTRU 920 may be configured with a reference RCS values for different target objects (e.g., reference object types, reference materials, or the like), and the WTRU 920 may determine the object material type based on the expected location of the object, the measured amplitude, or the amplitude distribution and the indicated reference RCS value.

In certain representative embodiments, measurement reporting is provided. For example, measurement report contents are provided. In one example, the WTRU 920 may be configured to report at least one or a combination of the following: path measurements, phase measurements associated with one or more paths, target object information, integer ambiguity reporting, combinations of the same, or the like.

For example, path measurements (e.g., with or without correction and/or compensation), include at least one of the following: one or more Path IDs; one or more Sensing path IDs (e.g., one of the one or more reported path IDs); path determination criteria (e.g., delay measurements, AoA measurements, or the like); measurements associated with one or more paths (e.g., RSRPP, phase, relative delay, WTRU Rx-Tx time per path, RSTD per path, or the like); references associated with one or more measurements (e.g., 1st path, LoS path, N-th path, or the like); one or more PRS resource IDs, one or more PRS beam IDs, one or more PRS resource set IDs, one or more TRP IDs, one or more cell IDs, or the like associated with the measurements; one or more associated DL RSs, one or more UL RSs with the one or more measured PRS resources, one or more beams, one or more resource sets and the relationship between (e.g., QCL relationship); uncertainties associated with different one or more path measurements; causes of the determined uncertainties; timestamp associated with measurements (e.g., in terms of symbol index, slot index, frame index, sub-frame index, or the like); indication if correction and/or compensation is applied, or the like; combinations of the same; or the like.

Also, for example, phase measurements associated with one or more paths (e.g., sensing path) (e.g., with and/or without correction and/or compensation) include at least one of the following: RSCP measurements associated with one or more paths; reference for RSCP measurements for one or more paths; relative RSCP measurements associated with one or more paths; reference (e.g., reference path) for relative RSCP measurements associated with one or more paths; RSCPD measurement associated with one or more paths; reference (e.g., reference TRP) for RSCPD measurements associated with one or more paths; RSCP measurement per antenna component per path; relative RSCP measurement per antenna per path for one or more paths; reference (e.g., reference phase, reference antenna element) for phase difference measurement per antenna component measurements associated with one or more paths; determined phase error groups (PEG) associated with the phase measurements; determined uncertainties associated with the phase measurements; causes of the determined uncertainties; one or more measured PRS resource IDs, one or more PRS beam IDs, one or more PRS resource set IDs, one or more TRP IDs associated with the phase measurements; one or more associated DL RSs, one or more UL RSs with the one or more measured PRS resources, one or more beams, one or more resource sets and the relationship between (e.g., QCL relationship); one or more path IDs (e.g., one or more sensing path IDs) associated with the phase measurements; measured frequency resources (e.g., in terms of RE index, RB index, PFL ID, Hz, MHz, or the like); timestamp associated with the phase measurements (e.g., in terms of symbol index, slot index, frame index, sub-frame index, or the like); indication if correction and/or compensation is applied; indication if phase measurement is reported standalone or along with other measurements (e.g., relative delay, RSTD, or the like); combinations of the same; or the like.

Further, for example, target object information includes at least one of the following: determined sensing target location and/or sensing target material; measurements (e.g., relative delay, phase measurements, or the like) associated with sensing targets (e.g., with and/or without compensation); indication if phase compensation or correction is applied; references associated with the measurements of the sensing target; phase correction factor (if applied); phase compensation factor (if applied); EO information (e.g., EO ID, phase value, amplitude value, or the like) of the phase compensation factor, (if applied); phase correction value applied (if applied); indication if the reference measurements (e.g., from the PRU) was applied to determine the phase measurements; combinations of the same; or the like.

In addition, for example, integer ambiguity reporting (e.g., in terms of measurements) includes at least one of the following: integer ambiguity value (e.g., in terms of number of wavelengths, delay and/or relative delay units such as number of symbols, slots, frames, subframes, seconds, or the like); measurements corresponding to the integer ambiguity value; combinations of the same; or the like. For example, the measurements corresponding to the integer ambiguity value include at least one of the following: relative delay measurements associated with one or more paths (e.g., sensing path); WTRU Rx-Tx time difference measurements for one of more paths (e.g., sensing path); RSTD measurements for one or more paths (e.g., sensing paths); references associated with the above measurements (e.g., reference path, reference TRPs); timestamp associated with the measurements (e.g., in terms of symbol index, slot index, frame index, subframe index, absolute time (e.g., hh:mm:ss, relative time, e.g., relative offset with respect to a reference time), or the like; one or more PRS resource IDs, one or more PRS beam IDs, one or more PRS resource set IDs associated with the measurements; one or more TRP IDs, one or more cell IDs associated with the measurements; offset value applied to any measurements for integer ambiguity (e.g., due to measurement with more than one PRS beams, one or more resources, one or more resource set IDs, one or more TRP IDs, one or more cell IDs, or the like); combinations of the same; or the like.

For example, conditions for measurement reporting are provided. In one example, the WTRU 920 may be configured to report the measurement aperiodically or periodically. For example, the WTRU 920 may be configured to report the measurement after a fixed duration of time with respect to a reference time.

In another example, the WTRU 920 may report the measurement based on at least one of the following conditions: the WTRU 920 determines expiration of the measurement window (e.g., after the end time); the WTRU 920 determines the sensing path; the WTRU 920 determines the object location and/or material type; the total number of performed measurement occasions are above a (pre)configured threshold; the WTRU 920 receives an indication from the network; the WTRU 920 determines to terminate the sensing procedure, or the like; combinations of the same; or the like.

In one example, the WTRU 920 may determine to terminate the sensing procedure for phase-based sensing based on at least one of the following conditions: expiry of measurement window; the WTRU 920 determines to report the phase measurements for sensing; the WTRU 920 does not detect any objects or determine any sensing path during measurement; the WTRU 920 does not detect any object or determine the sensing path within the indicated measurements range; the WTRU 920 does not determine or detect a reference path (e.g., within the measurement range, indicated PRS resource, beam, resource set, or the like); the WTRU 920 does not determine the integer ambiguity value or measurements corresponding to the integer ambiguity value; the WTRU 920 determine that the uncertainty associated with the object location is above a (pre)configured threshold; the WTRU 920 determines that the uncertainty associated with at least one of the measurements (e.g., relative delay, phase, or the like) is above a (pre)configured threshold; combinations of the same; or the like.

In one example, in case of at least one of the above conditions being satisfied, the WTRU 920 may terminate the sensing procedure and report the event and measurements to the network.

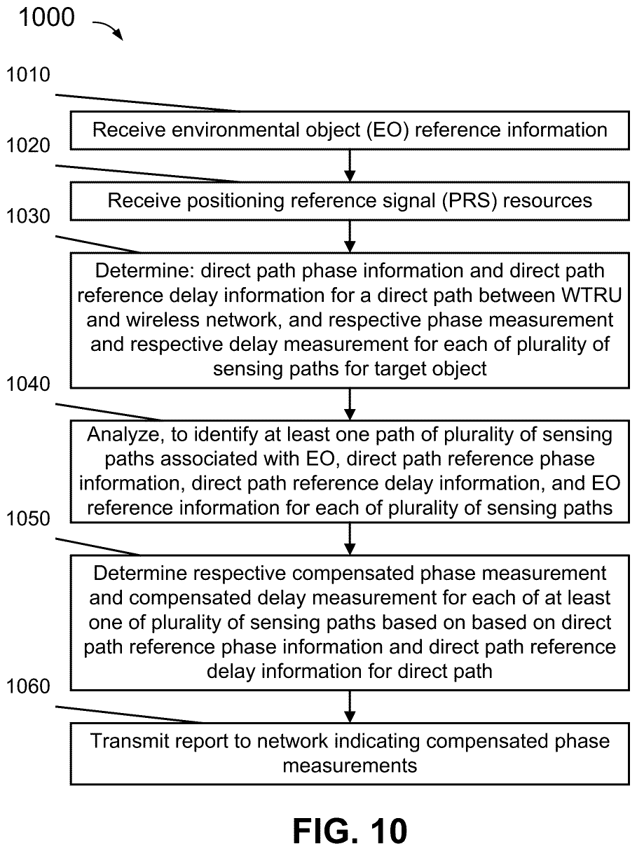

In certain representative embodiments, as shown in FIG. 10, a method 1000 performed by a wireless transmit/receive unit (WTRU) (e.g., 102, 320, 420, 530, 620, 820, 920, or the like), in communication with a wireless network (e.g., TRP 310, TRP 410, TRP 510, network 610, TRP 810, TRP 910, or the like), is provided for a sensing task. For example, the method comprises receiving (e.g., at 1010), from the wireless network, environmental object (EO) reference information. Also, for example, the method comprises receiving (e.g., at 1020), from the wireless network, positioning reference signal (PRS) resources. Further, for example, the method comprises, based on the PRS resources, determining (e.g., at 1030): direct path reference phase information and direct path reference delay information for a direct path between the WTRU and the wireless network, and a respective phase measurement and a respective delay measurement for each of a plurality of sensing paths (e.g., sensing paths, FIG. 8; Path 2, FIG. 9; or the like) for a target object (e.g., 830, 940). In addition, for example, the method comprises analyzing (e.g., at 1040), to identify at least one path of the plurality of sensing paths associated with an EO (e.g., EO ID #1, FIG. 8; 930), the direct path reference phase information, the direct path reference delay information, and the EO reference information for each of the plurality of sensing paths. Moreover, for example, the method comprises determining (e.g., at 1050), based on the analyzing, a respective compensated phase measurement and a respective delay measurement for each of the at least one of the plurality of sensing paths based on the direct path reference phase information and the direct path reference delay information for the direct path. Furthermore, for example, the method comprises transmitting (e.g., at 1060) a report to the network indicating the compensated phase measurements.

In some embodiments, for example, the method comprises receiving, from the wireless network, direct path reference phase information and direct path reference delay information for a direct path (e.g., LoS path, reference path, FIG. 8; Path 1, FIG. 9; or the like) between the WTRU and the wireless network.

In certain representative embodiments, a wireless transmit/receive unit (WTRU) (e.g., 102, 320, 420, 530, 620, 820, 920, or the like), in communication with a wireless network (e.g., TRP 310, TRP 410, TRP 510, network 610, TRP 810, TRP 910, or the like), for a sensing task is provided. For example, the WTRU comprises a processor (e.g., 118). Also, for example, the WTRU comprises a transceiver (e.g., 120) coupled to the processor. Further, for example, the WTRU is configured to receive (e.g., at 1010), from the wireless network, environmental object (EO) reference information. In addition, for example, the WTRU is configured to receive (e.g., at 1020), from the wireless network, positioning reference signal (PRS) resources. Moreover, for example, the WTRU is configured to, based on the PRS resources, determine (e.g., at 1030): direct path reference phase information and direct path reference delay information for a direct path between the WTRU and the wireless network, and a respective phase measurement and a respective delay measurement for each of a plurality of sensing paths (e.g., sensing paths, FIG. 8; Path 2, FIG. 9; or the like) for a target object (e.g., 830, 940). Furthermore, for example, the WTRU is configured to analyze (e.g., at 1050), to identify at least one path of the plurality of sensing paths associated with an EO (e.g., EO ID #1, FIG. 8; 930), the direct path reference phase information, the direct path reference delay information, and the EO reference information for each of the plurality of sensing paths. Additionally, for example, the WTRU is configured to determine (e.g., at 1060), based on the analyzing, a respective compensated phase measurement and a respective delay measurement for each of the at least one of the plurality of sensing paths based on the direct path reference phase information and the direct path reference delay information for the direct path. Still further, for example, the WTRU is configured to transmit (e.g., at 1070) a report to the network indicating the compensated phase measurements.

In some embodiments, for example, the WTRU is configured to receive, from the wireless network, direct path reference phase information and direct path reference delay information for a direct path (e.g., LoS path, reference path, FIG. 8; Path 1, FIG. 9; or the like) between the WTRU and the wireless network.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU) in communication with a wireless network, the method comprising:
receiving, from the wireless network, environmental object (EO) reference information;
receiving, from the wireless network, positioning reference signal (PRS) resources;
based on the PRS resources, determining:
direct path reference phase information and direct path reference delay information for a direct path between the WTRU and the wireless network, and
a respective phase measurement and a respective delay measurement for each of a plurality of sensing paths for a target object;
analyzing, to identify at least one path of the plurality of sensing paths associated with an EO, the direct path reference phase information, the direct path reference delay information, and the EO reference information for each of the plurality of sensing paths;
based on the analyzing, determining a respective compensated phase measurement and a respective delay measurement for each of the at least one of the plurality of sensing paths based on the direct path reference phase information and the direct path reference delay information for the direct path; and
transmitting a report to the wireless network indicating the compensated phase measurements.

2. The method of claim 1, wherein the EO reference information comprises EO reference delay information with respect to the direct path.

3. The method of claim 2, comprising determining a delay uncertainty for the at least one of the plurality of sensing paths based on the EO reference delay information.

4. The method of claim 3, comprising comparing the delay uncertainty to a threshold,
wherein the compensated phase measurements are triggered by the delay uncertainty above the threshold.

5. The method of claim 1, wherein the EO reference information comprises EO reference phase information with respect to the direct path.

6. The method of claim 5, wherein the EO reference phase information comprises relative amplitude and relative phase information with respect to the direct path associated with the EO.

7. The method of claim 6, wherein the determining the respective compensated phase measurement for each of the at least one of the plurality of sensing paths is performed with respect to a phase of the direct path.

8. The method of claim 1, wherein the EO reference information comprises a validity time duration associated with the EO.

9. The method of claim 8, comprising comparing a duration of an instance of the phase measurements to the validity time duration,
wherein the compensated phase measurement for the instance is triggered by the duration being within the validity time duration.

10. The method of claim 1, wherein the report to the wireless network further indicates the delay measurements, uncertainties of the delay and phase measurements, and one or more compensated EOs.

11. A wireless transmit/receive unit (WTRU) in communication with a wireless network, the WTRU comprising:
a processor; and
a transceiver coupled to the processor, wherein the WTRU is configured to:
receive, from the wireless network, environmental object (EO) reference information;
receive, from the wireless network, positioning reference signal (PRS) resources;
based on the PRS resources, determine:
direct path reference phase information and direct path reference delay information for a direct path between the WTRU and the wireless network, and
a respective phase measurement and a respective delay measurement for each of a plurality of sensing paths for a target object;
analyze, to identify at least one path of the plurality of sensing paths associated with an EO, the direct path reference phase information, the direct path reference delay information, and the EO reference information for each of the plurality of sensing paths;
based on the analyzing, determine a respective compensated phase measurement and a respective delay measurement for each of the at least one of the plurality of sensing paths based on the direct path reference phase information and the direct path reference delay information for the direct path; and
transmit a report to the wireless network indicating the compensated phase measurements.

12. The WTRU of claim 11, wherein the EO reference information comprises EO reference delay information with respect to the direct path.

13. The WTRU of claim 12, wherein the WTRU is configured to determine a delay uncertainty for the at least one of the plurality of sensing paths based on the EO reference delay information.

14. The WTRU of claim 13, wherein:
the WTRU is configured to compare the delay uncertainty to a threshold, and
the compensated phase measurements are triggered by the delay uncertainty above the threshold.

15. The WTRU of claim 11, wherein the EO reference information comprises EO reference phase information with respect to the direct path.

16. The WTRU of claim 15, wherein the EO reference phase information comprises relative amplitude and relative phase information with respect to the direct path associated with the EO.

17. The WTRU of claim 16, wherein the WTRU is configured to determine the respective compensated phase measurement for each of the at least one of the plurality of sensing paths with respect to a phase of the direct path.

18. The WTRU of claim 11, wherein the EO reference information comprises a validity time duration associated with the EO.

19. The WTRU of claim 18, wherein:
the WTRU is configured to compare a duration of an instance of the phase measurements to the validity time duration, and
the compensated phase measurement for the instance is triggered by the duration being within the validity time duration.

20. The WTRU of claim 11, wherein the report to the wireless network further indicates the delay measurements, uncertainties of the delay and phase measurements, and one or more compensated EOs.
